(19) United States
(12) Patent Application Publication
(10) Pub. No.: US 2017/0337180 A1
(43) Pub. Date: Nov. 23, 2017

(54) RECOGNITION METHOD AND SYSTEM OF NATURAL LANGUAGE FOR MACHINE THINKING

(71) Applicant: Lishan Wang, Guangzhou (CN)

(72) Inventor: Lishan Wang, Guangzhou (CN)

(21) Appl. No.: 15/224,505

(22) Filed: Jul. 29, 2016

(30) Foreign Application Priority Data
May 23, 2016 (CN) 201610349629.6

(51) Int. Cl. G06F 17/27; G06F 17/28

(52) U.S. Cl. CPC G06F 17/2765; G06F 17/2836; G06F 17/274; G06F 17/2785; G06F 17/2795

(57) ABSTRACT

A recognition method of natural language for machine thinking, consisting of the following procedures: (1) Establishing a database matching with predicate calculus-like form word meanings. (2) Inputting natural language information. (3) Segmentation processing of said natural language for machine thinking line by line, and transition to be one or more than one predicate calculus-like form sentence according to segmentation processing rule. (4) Converting said multiple predicate calculus-like form sentence to electrical signal recognized by machine, and then input them to center processing unit, and undertake more than one procedures from search, recognition, recursion and substitution to execute functional process with logic deduction, metaphor or creative thinking in order to create new combination for digital codes. (5) Converting said digital codes combination retrospectively to a new natural language matching original natural language information input and store them as output or learning outcome.

### FIELD OF THE INVENTION

This invention is related to the process and research of natural language, especially for the consistency of machine thinking and human thoughts. This invention will make the machine speak, learn, think and solve problems like human beings.

### BACKGROUND OF THE INVENTION

With the development of the Artificial Intelligence (AI), several products of the AI have been used in different social fields. The final target, however, of the AI is to communicate with human by using human's thoughts and languages. At present time, the AI can't achieve this goal since the shortage of methodology and technology.

### SUMMARY OF THE INVENTION

This invention tries to figure out the shortage above and issue subversive methodology related to the AI. Besides, it will provide method for transforming the natural language to machine thinking thus to realize the consistence of the human thoughts and the machine thinking. It will make the machine think like the human and interact with the human.

Technical plans of this invention are as follow:

The recognition methods of natural language for machine include the following steps: (1) to establish the database which corresponds to the predicate calculus-like form word meaning; (2) to input the natural language; (3) to segment the natural language sentence by sentence and transform it to one or more calculus sentence of predicate calculus-like form by the rule of segmentation; (4) to transform the predicate calculus-like form sentence to the electrical signal which can be recognized by the machine. Then the electronic signal will be input into the central processing unit. The electronic signal will be searched, recognized, recurred or replaced. One of the methods above will be carried out to do logical reasoning, metaphor or functional process by associating creative thinking. It will generate new digital code combination; (5) to backtrack and transform the digital code to the new natural language which corresponds with the natural language information input. Then the new natural sentences will be output. Or we can store the new language sentence as the learning result.

The definition of the predicate calculus-like form in this invention is : the natural language sentence pattern is consisted of one of the four simplest thinking modes or combinations. Each simplest thinking mode includes the simplest sentence pattern of predicate. It is similar to the existing presentation method of predicate calculus. The four simplest thinking methods are defined as the predicate calculus-form.

The database in this invention includes at least the new code database encoded by the natural number. The new code database is established by manually inputting or using existing opening code source.

The segmentation rule of this invention is: to segment the inputted natural language information into one or more predicate calculus-like form sentences and save each piece's meaning. Each predicate calculus-like form sentence is the simplest sentence consists of three terms at most a group; the sentence corresponds to the natural language information will be transformed to a set consists of several sequences three terms a group.

The segmentation rule will be realized by the following calculus mode:

(1) a period marks the terminal of one sentence meaning, a paragraph marks the terminal of a group of sentence meaning, an article marks the terminal of a group of paragraph meaning; to search the predicate as the middle term in the simplest sentence as a whole and make comparison with the database in order.

(1.1) To determine the sentences' components of the front and back terms of the first level by taking the predicate as the boundary line. Thus to determine the front term as the simplest sentence pattern first term of the first level. And to determine the back term as the simplest sentence third term of the first level.

(1.2) If the predicate in the sentence is omitted, then we need to add predicate firstly and repeat step 1.1.

(2) To do the second level segmentation of the front and back terms of the sentence pattern in order and repeat the segmentation procedure of step 1.

(3) To take the limited subject of the determiner as the simplest pattern first term in the next level. To add predicate for the second term. And the third term is the determiner.

(4) To do the segmentation above in the next level until the sentence is fully segmented.

The algorithm model for searching the predicate of the sentence of this invention is:

(1) To compare the words of one sentence with the language database. The database outputs the attributes of the words in the sentence. To carry on the search until the first predicate is searched out. The search will be done until there is no more predicate; the term before the judging words or verbs is the subject and the term after the judging words or verbs is the expressing words or object. Then the simplest sentence pattern is found out.

(2) To carry on the search if the second predicate is searched out. The search will be done until there is no more predicate; the term before the predicate is the subject and the term after the predicate is the expressing words or object. Then the composite structure of the simplest sentence pattern is found out.

After the natural language information is transformed to the predicate calculus-like form, the automated reasoning and association process is: the segmented sentences become the set of the simplest thinking model consists of the words three terms a group.

(1) According to the principle of time priority, we use the third term of the first sequence of the first sentence to minus the first term of the first sequence of the second sentence. If this results zero and the second term of the first sequence of the first sentence minus the second term of the second sequence equals zero, then the third term of the first sequence of the first sentence shall be replaced by the first term of the second sequence of the second sentence; the new first sequence of the first sentence is established.

(1.1) If we don't have the result above, then use the third term of the first sequence of the first sentence to minus the first term of the third sequence of the secondary two sentences. If this results zero and the second term of the first sequence of the first sentence minus the second term of the third sequence of the secondary two sentences equals to zero, then the third term of the first sequence of the first sentence shall be replaced by the first term of the third sequence of the secondary two sentences; the new first sequence of the first sentence is established;

(2) To use the third term of the first sequence minus the first term of the secondary sequence (the first term of the secondary sequence has finished the calculation of step 1). If this results zero and the second term of the first sequence minus the second term of the secondary sequence (the second term of the secondary sequence has finished the calculation of step 1) equals zero, then the third term of the first sequence shall be replaced by the first term of the secondary sequence which has finished the calculation of step 1; the new first sequence is established;

(3) To carry on the procedure above until the procedure can not be proceeded, then stop the procedure; output the new first sequence and this is the result of reasoning.

(4) If the selected sequence can not be proceeded through the procedure above, then to select the secondary sequence for the procedure above;

(5) The conclusion shall be outputted whether there is reasoning result or not. The incomplete logical reasoning and judging calculus model is based on the calculation of the predicate calculus-like form which transformed from the natural language:

(1) In the sentence pattern, to use the individual replace the kind and take individual as the assignment of the variable kind. Or to use kind replace individual. This will depend on the demand of the reasoning target. The terminal abstract concepts(like the totally different abstract concept “order” and “disorder”, “good ” and “bad”) are in the same relation with their inclusive specific concepts.

(2) In the sentence pattern, the sentence will be null if the reasoning result is that the sub-sentence contradicts to the main expression.

(3) In the same action chain, the main behavioral agent which has the causal relation can replace the latter with the former under the causal order. (This will be determined by the uniqueness limited by the time and space of the causal relation).

In the replacement calculation, if the entire kind concept W includes the individual concepts which belong to the same kind, like W₁, W₂, . . . , wn. And W₁, W₂, . . . , Wn respectively equals to W, then W can be replaced in the sentences(the equivalence relation between the universal concept and the specific concept).

(4) WHAT₁ BE WHAT₂ is reversed to be WHAT₂ BE WHAT₁, and they are equivalent.

(5) In the mode of WHAT₁ Do WHAT₂, Do equals to WHAT₂.

(6) As the third term in the sentence, WⱼDWⱼ₊₁ can be independent and has entire meaning. It can be formed as a new sentence by combination with WDW. As the third term, WⱼD can be canceled. And Wⱼ₊₁ is reserved only. The sentence will be reduced into the central meaning sentence.

(7) To eliminate the determinative expression of DO which is one of the four basic thinking models that initially segmented from the sentence. And to reserve WHAT of the last DO of the same sentence. If WHAT belongs to BE kind, than both sides of BE equal to each other and become two simplified sentences.

(8) Three parameters of the basic model (fully segmented) can replace each other in the same condition excluding BE. The same word in each sentence can be replaced with an equivalent word.

The machine translation is based on the calculation of the predicate calculus-like form transformed from the natural language information :

To translate two different languages (have been segmented) through machine automatically by using this invention. This invention is based on the natural model of human thoughts. Thus, different languages is different from each other in details. The basic structures, however, are all the same. There will be another language corresponds to the set of the segmented simplest thinking model. Translation is to transform the words of the simplest thinking model to the other matching language.

(1) segmentation of the sentence

The simplest thinking model constructs the basic translation sentence with the determiners of each word.

(2) The attribution related to the action of the behavioral subject must be determined specifically in English. And the Chinese words will be omitted.

(3) The abstract meaning of “existence” must be expressed in English and omitted in Chinese.

(4) WHAT₁BE of WHAT₂ equals to WHAT₁ HAS WHAT₂

(5) Abiological behavioral agent is more in English than in Chinese. Usually, the abiological behavioral agent is expressed in metaphor and quite different in terms of the choice of words.

(6) “IT”, as the behavioral agent, appears a lot in English. And to keep the balance of beginning and end of the sentence, the sub-sentence is usually put in the end of the sentence and “it” is put in the beginning as the subject. The passive voice shall be transformed to active voice.

(7) To replace the translation words of the segmented simplest pattern. Then to backtrack and generate the translation sentences.

The mathematical machine thinking is based on the calculation of the predicate calculus-like form transformed from the natural language information:

To express the mathematical machine thoughts by natural language and solve the issue automatically by using this invention. Through generalization, different models of solving problems transformed from those predicate calculus-like form of the natural languages will be concluded.

The calculus model for the mathematical problems-solving of the natural language predicate calculus-like form is:

(1) To establish a model for the problems-solving. The model shall include the synonyms. To set the words in different location of the simplest pattern as the word list [X] contains sole synonyms or the synonymous determiners. The model shall correspond to all the natural sentences of the same meaning;

(2) To segment the mathematical problems expressed in words into the predicate calculus-like form;

(3) To realize the problems-solving procedure by a series of recursion and substitution bonded by the same words of the problems-solving model;

(4) To enter the calculus procedure for calculation;

(5) Track back automatically and generate the answer by outputting the sentences.

The machine learning is based on the calculation of the predicate calculus-like form transformed from the natural language information. The machine can search and identify the same kind concepts(words) or contrary concepts(words) according to the similarity of the Gestalt structure of the words(concepts). The series words for expressing behavior can also be searched through the same way and stored as the learning result in the word database. The machine learning can also store the reasoning results as the new knowledge in the knowledge database.

The machine automatically programming is based on the calculation of the predicate calculus-like form transformed from the natural language information.

This invention also provides an identify system based on the natural language for machine thinking. Its features include human-machine interface module, sentences segmentation module, central processing unit, sentences synthesis module and database module. The segmentation module and the sentences pattern synthesis module respectively connects the input end and output end through electrical signal. The database module at least includes the word database management module.

The database module of this invention belongs to the multi-bases cooperation module. This database module also includes knowledge database management module, situational database management module, multi-semantic internet database management module and the metaphor internet database management system. Different kind database, based on the predicate calculus-like form transformed from the natural language information, can be applied directly to both the sentences calculation and the natural language for machine thinking.

Compared with present technology, this invention has the following advantages:

The base of the natural language sentences is the basic thinking expression model. This is similar to the predicate calculation. This invention can realize the fully and automatically transformation between the natural language and the predicate calculation. Thus to lay the foundation of the realization for AI directly using human natural language. And let AI has the same thinking carrier—language system as human beings. The basic intelligent system is the same. For the transformation contains the entire sentence meaning, thus the technical path of the human language directly used by the machine is fully realized. This reflects on the basic thinking expression way and the expression of reasoning, metaphor and association. These reflections transformed from the natural language predicate calculus-like form proposed and analyzed in this invention.

To realize the AI through this invention. And to make the machine speak, learn by reading, reason, think and solve problems through natural language information(words for example) like human beings. Thus, it is the nearest to human brain. The most effective way for machine to communicate with human is that the machine directly uses the natural language system as the communication tool.

The identify methods and system of the natural language for machine thinking of this invention can be widely applied in different fields. For example, this invention can help people extract the abstract or theme of article; it can be applied in the intelligent internet search; it can be applied in reading and understanding articles and books as well as the classification and translation automatically; it can make machine learn knowledge automatically and expand the knowledge database automatically; it can make machine use other AI professional software through reading natural language; it can also make robot have natural language thinking and communicate with human beings.

### BRIEF DESCRIPTION OF THE DRAWINGS

FIG. 1: the work flow chart of this invention

FIG. 2: the tree structure of the sentence

FIG. 3: the block diagram of the invention's working principle

Specific mode of execution

Next, I will make a detailed specification combined with the specific mode of execution on the technical project. This detailed specification, however, will not cause any limitation on this invention.

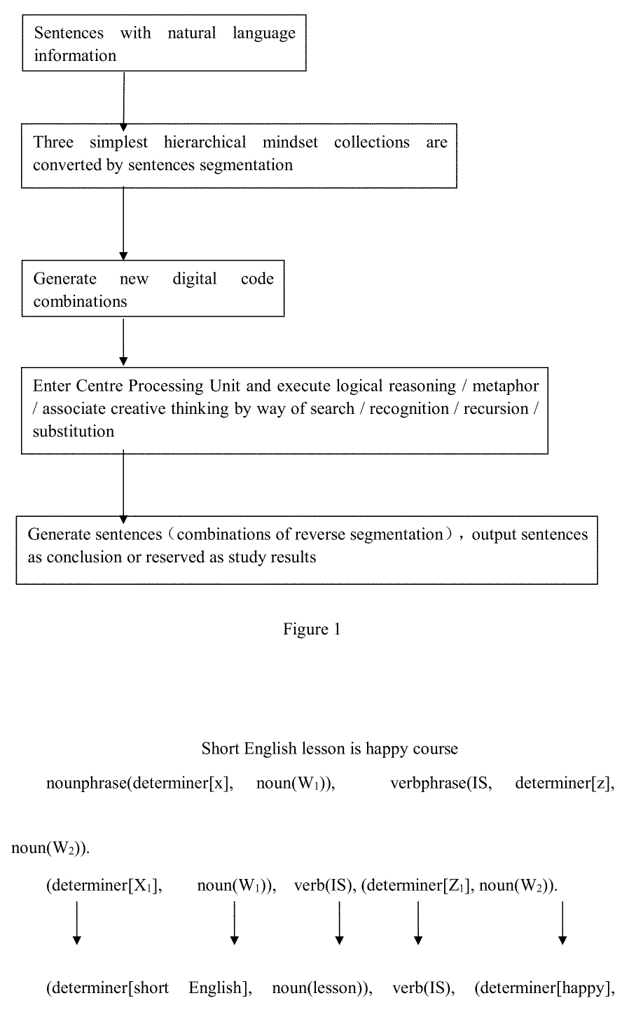

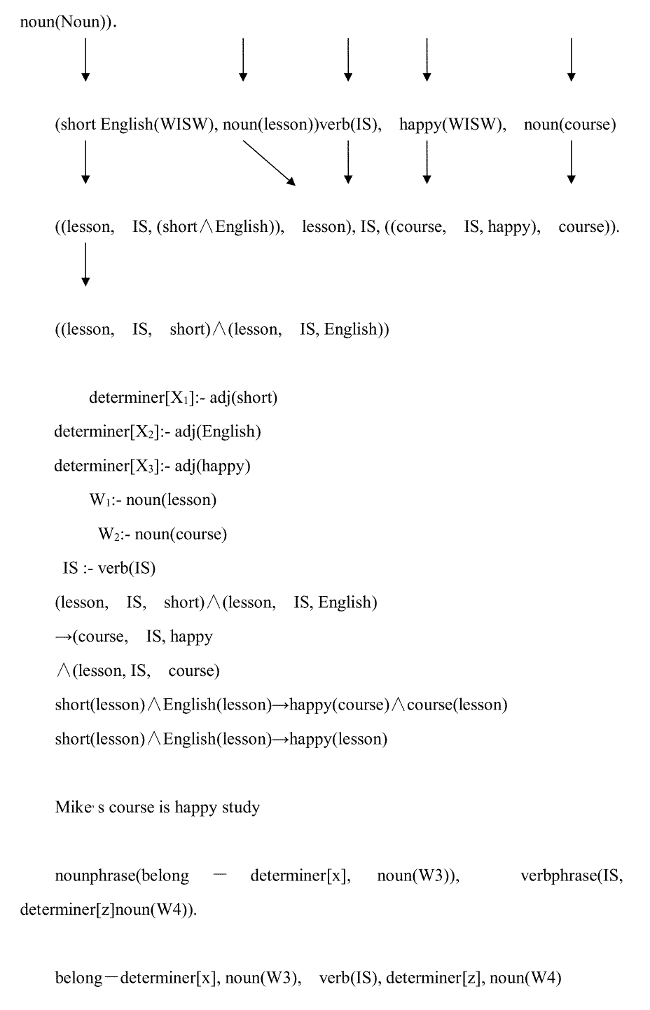

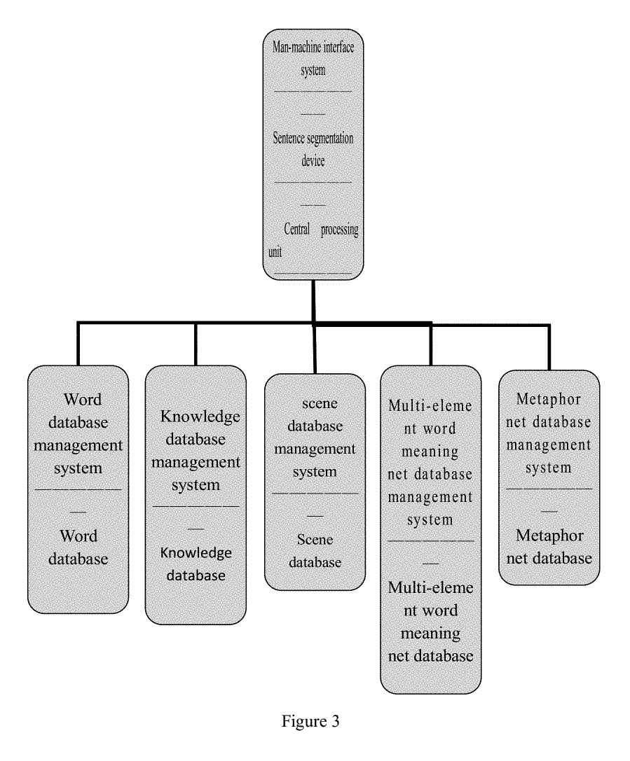

As shown in FIG. 1 and FIG. 3, the specific mode of execution includes the following steps:

(1) To establish the database corresponds to the word meaning of the predicate calculus-like form

(2) To input the natural language information.

(3) To segment the sentences of the natural language information sentence by sentence and transform them to one or more predicate calculus-like form sentences by the segmentation rule

(4) To transform several predicate calculus-like form sentences to the electrical signal which can be identified by the machine. Then input the electrical signal to the central processing unit for logical reasoning, metaphor or associated creative thinking through at least one of the following methods: searching, identifying, recursion or substitution. And the new digital code combination will be generated.

(5) To backtrack the digital code combination and transform it to the new natural sentences correspond to the inputted natural language information. Then to output the new natural sentences or store them as the learning results.

### DETAILED DESCRIPTION

1. The Basic Features of Thinking

Human's thinking is the reflection of world's phenomenon and relation. Such reflection appears as the naming of objects and the naming and description of events. The description of objects and events can be summarized as four situations, they are: WHAT BE WHAT, WHAT BE STATUS, WHAT BE WHERE and WHAT DO WHAT. The four situations can be combined by each other. And these four situations are called the basic model of thinking by this invention. The contrary situations are passive situations: things are defined as what, things are considered in what status, things are considered in where, things are caused by what. These are determined by the natural principle of interaction. That means the effective process is participated by agent and passives. Since the action and reaction happened simultaneously, the two participants are agent and passives respectively. The only difference between agent and passives are the characteristics of time and space. And this is determined by the uniqueness of time and space.

1.1 The Understanding of Natural Language

Since the language itself is a symbol system, so understanding means to get the core sentence meaning and extend meaning from the sentence, paragraph and article. Under the base of understanding, the machine thinking can imitate human thinking if the machine responses to the original text automatically. Otherwise, the machine will be regarded as the database if the machine thinking is asked questions.

Natural language is the carrier of thinking and sentence pattern is the organized structure of human thinking. Sentence structure is organized by one or several basic thinking models.

One word can be a verb or a noun, which depends on its role in the description or the location in the sentence. Noun is the naming of behavior itself. Verb is the naming of the status of the behavior. Thus, “run quickly ” equals to “run is quick”.

Most often, a determiner is prescribed to the noun for proper description since the noun is abstract. And this is the determinant attribute of the noun. The determinant attributes include determiner of morphology, determiner of attribution, etc. The determinant attributes of the verb usually are the adverb of degree.

1.2 Sentence Pattern

Sentence pattern is the reflection of the relation and time sequence between events and objects. It has the recursion structure(self-similarity) of the four basic models or their combinations above. The match of words depends on the their logical relation of gestalt dimension. The logical relation here means the broad relation of cause and effect, similarity and relevance.

2. Four Basic Thinking Models

Language is the carrier of thinking. The basic model of thinking is also the basic form of sentences. According to the introduction, there are four basic thinking models.

\textcircled{1}“WHAT BE WHAT”

\textcircled{2}“WHAT DO WHAT”

\textcircled{3}“WHAT BE WHERE”

\textcircled{4}“WHAT BE STATE”

WBW(“WHAT BE WHAT”)

=(determiner[x], noun(WHAT1), BE, determiner[z]noun(WHAT2)).

WDW(“WHAT DO WHAT”)

=(determiner[x], noun(WHAT), determiner[y]verb(DO), determiner[z]noun).

WBWH(“WHAT BE WHERE”)

=(determiner[x], noun(WHAT), BE, determiner[z]noun(Where)).

WBST(“WHAT BE STATE”)

=(determiner[x], noun(WHAT), BE, determiner[z]adjective(State)).

When determiner is empty set, the sentence is the simplest pattern.

3. How to Segment the Sentence into the Basic Thinking Models?

Sentence is the carrier of thinking. The natural order of different words(concepts) is the order of thinking. Also, it's the natural time order of behavioral agent and process of event in progress. The reversed word order is the expression of thinking skills.

A relatively entire sentence is split at the punctuation-boundary. The sentences between the comma are in the relation of “conjunction ”( [symbol] ) and “or”( [symbol] ). Maybe it's the cause and effect relation. In Chinese, the determinate attributes are usually put in the subject terms like noun, pronominal subject, verbal predicate. These are the bases of WHAT and DO. The noun before the verb in the back of the sentence, especially the noun after “ [symbol] ” and WHAT-clause, meanwhile the verb after the noun is DO and another WHAT-clause. The other situation is on the contrary. If a noun or pronoun is on the initial of the sentence and followed by BE verb, then the basic thinking models can be used directly for the sentence segmentation. The meaning of sentences of each level is kept entirely by segmenting the sentences into the basic thinking models. The simplest sentence is the sentence that consists of at most three terms. And the simplest sentence can be transformed to the predicate calculus model directly.

3.1 The Calculus Model of Sentence Segmentation

1. The period marks the terminal of sentence meaning. The paragraph marks the terminal of the group of sentence meaning. The article marks the terminal of the group of paragraph. Bounded by the comma, to search the middle term “BE, DO” in the whole sentence and make the comparison with the word database.

1.1 To make the comparison according to the searching calculus and determine the WHAT-clause in tandem. Thus to determine the front term WHAT₁ as the first term of the simplest pattern of the first level and the back term WHAT₂ is the third term of the simplest pattern of the first level.

1.2 If the middle term “BE, DO” of the sentence is omitted, then the complement procedure shall be proceeded and the step 1.1 shall be repeated.

1.3 If the sentence is determined as the coordination of related terms (for example, some poems are in this case) after searching and comparison, then the poetry and prose segmentation procedure shall be proceeded.

2. To segment WHAT₁ and WHAT₂ orderly on the second level and repeat the segmentation procedure of 1.

3. The subject word of determiners is the first term of the simplest pattern of the next level. BE shall be added to the second term and the third term is the determiner. Determiners here refer to the words play definitive role, like “ . . . [symbol] ”, “ . . . [symbol] ” , description, quantifier and the noun before the subject noun which play definitive role.

4. To do the segmentation procedure on the next level until the segmentation is completed.

5. The clauses of natural language are bounded by comma. Some kind of logical relation lies between each clause. Or the paralleling expression lies between each clause. In the clause led by conditional words, the comma shall be replaced with the sign “→” of consequence clause to mark the cause and effect relation of these two clauses.

The Searching Calculus Model of Predicate of BE or DO

1. To make the word of a sentence compare with the word database in order. And the database will output the attributes of each word of the sentence. The search will be continued until the first judging word or verb is searched out. The search will be finished if there is no more judging word or verb. The term before the judging word or verb is the behavioral agent. And the term after the judging word or verb is the expressive word or passives. Then the basic sentence model is found out.

2. If the second judging word or verb is found out, the search will be continued. If there is no more judging word or verb, then the search is finished. The term before the judging word or verb is the behavioral agent. And the term after the judging word or verb is the expressive word or passives. Generally speaking, it is the longest sentence structure. Then the composite structure of the basic sentence model is found out.

1.1 If there are less terms of subject in the first basic sentence, then basically the first basic sentence model can be judged as the main structure and the second basic sentence model can be judged as the secondary structure of the whole sentence. The subject of the first basic sentence model is the subject of whole sentence.

1.1.1 To calculate and compare the number of the subject terms with the terms after predicate. If the subject terms are less, then output the judgment that this basic sentence model is the main structure of the whole sentence.

1.2 If the expressive words or passives of the second basic sentence model are less than the subject terms of the first basic sentence model, then basically the second basic sentence model can be judged as the main structure of the whole sentence. The first basic sentence model is the subject of the whole sentence.

1.2.1 To calculate and compare the number of the expressive words or passives of the second basic sentence model with the subject terms of the first basic sentence model. If the number of the expressive words or passives are less, then output the judgment that the second basic sentence model is the main structure of the hole sentence. If not, then output the judgment that the first basic sentence model is the subject of the whole sentence.

(Next is a kind of relatively simple sentence pattern. The calculus model of different sentence pattern is the same.)

2. After the main structure of the whole sentence is found out, each term before the predicate of the sentence main structure will be marked as W₁. These terms will be moved out and become one sequence. Each term after the predicate will be marked as W₂ and these terms will be moved out and become another sequence.

2.1 To do the search of step 1. among W₁ and find out the head noun. To reorder the code of the head noun and reorder the words with other characteristics. The order is as follows:

the head noun, the judging word “ [symbol] ”, “ [symbol] ” or verb, predicative or object

If W₁ is consists of only 3 terms, then it is the simplest basic sentence pattern. The segmentation is terminated.

2.1.1 To copy the head word of W₁

2.1.2 If there are only two terms and without judging word “ [symbol] ” or “ [symbol] ”, then to fill up the vacancy. To introduce the code of “ [symbol] ” or “ [symbol] ” and reorder them as follows:

the head noun, the judging word “ [symbol] ”, “ [symbol] ”, predicative

The reordered W₁ is named as RW₁

2.2 To do the search of step 2.1 among W₂

If the predicate of the sentence's main structure is the judging word “ [symbol] ” or “ [symbol] ”, then the head word of W₂ is predictive; if the predicate is verb, then the head word is noun. To copy the head word of W₂. The reordered W₂ is named as RW₂.

2.3 To sort the order “head word of W₁, head word of W₂, predicate of the sentence's main structure” as “head word of W₁, predicate of sentence's main structure, head word of W₂”

2.4 To reorder the sequence of the original sentence into the set of sequence consists of three terms:

(head word of W₁, the predicate of sentence's main structure, head word of W₂) [symbol] (RW₁) [symbol] (RW₂)

The searching calculation model for judging the phrases

1. To compare the sum of the first number plus the second number with the word database. If it can be recognized, then the two words coded by these two number are combination phrase. (if the sum can't be recognized, then the sum represents a word and the judgment will be terminated. To restart step 1. from the word(the second number)).

2. The third number plus the sum of first and second number. If it still can be recognized, then the three words correspond to the three number represent a combination word consists of three words.(if the sum can't be recognized, then to terminate the judgment and restart step 1. from this word(the third number))

3. The fourth number plus the sum of the first three numbers. If it can be recognized, then the sum of the four number represents a combination word consists of four words. (if the sum can't be recognized, then to terminate the judgment and restart step 1. from this word(the fourth number))

4. N+1 plus the sum of N numbers. If it can be recognized, then the n+1 words which correspond to the sum of n+1 numbers represent a combination word consists of n+1 words.(if the sum can't be recognized, then the judgment will be terminated and restart step 1. from this word (the n+1 number))

5. To repeat the procedure above until the recognize is failed. The latter numbers will be done the same procedure until the judging word “ [symbol] ” , “ [symbol] ” and the verb with sole part of speech are found out.

6. To find out the subject phrases by the above way. Then to output the result.

Note:

Generally, the sentence won't be too long (here the sentence means the expressive parts split at the punctuation-boundary). Mostly, an entire sentence's main structure consists of the sole model. There won't be more than three basic models. Next is the specification based on some sentence patterns.

BE means “existence”. BE includes the words for expressing the determined meaning of time and space: “in”, “on”, “by”, “for”, “only”, “from”, “with”, etc.

We use the following segmentation of the example sentence to explain how to transform the natural language to predicate calculus-like form directly:

Example 1: She plays Mozart with a rare grace and delicacy of touch. (rather formal>(Grammar of English communication, p55)

She plays Mozart with a rare grace and delicacy of touch

=(She, plays, Mozar with a rare grace and delicacy of touch)
=(She, plays, Mozar [symbol] She with a rare grace and delicacy of touch)
   =(She, plays, Mozar [symbol] (She, with, a rare grace and delicacy of touch))
      =(She, plays, Mozar [symbol] (She, with, a touch(a touch, IS, rare (grace [symbol] delicacy))))

=(She, plays, Mozar [symbol] (She, with, a touch(a touch, IS, (grace [symbol] delicacy, IS, rare))))
=(She, plays, Mozar [symbol] (She, with, a touch(a touch, IS, (grace [symbol] delicacy)(grace [symbol] delicacy, IS, rare))))

=((She, plays, Mozar) [symbol] ((She, with, a touch) [symbol] (a touch, IS, grace [symbol] delicacy) [symbol] (grace [symbol] delicacy, IS, rare))))

=((She, plays, Mozar) [symbol] (She,with, a touch) [symbol] (a touch, IS, grace) [symbol] (a touch, IS, delicacy) [symbol] ((grace, IS, rare) [symbol] (delicacy, IS, rare))))

We can extract reversely from the bottom. To simplify the structures on different levels as the simplest patterns and extract them out. The specific method is as follow:

((She, plays, Mozar) [symbol] (She, with, a touch) [symbol] (a touch, IS, grace) [symbol] (a touch, IS, delicacy) [symbol] ((grace, IS, rare) [symbol] (delicacy, IS, rare))))
(1) To extract the bottom simplest pattern (Bottom):

(grace, IS, rare) [symbol] (delicacy, IS, rare)

(2)To simplify the structure on the up level and extract it out(Third floor):

(a touch, IS, grace) [symbol] (a touch, IS, delicacy)

(3) To simplify the structure on the up level of (2) and extract it out(Second floor):

(She, with, a touch)

(4) To simplify the topside structure and extract it out(Top floor):

(She, plays, Mozar)

To combine the four levels above and get:

(She, plays, Mozar)

[symbol] (She, with, a touch)

[symbol] (a touch, IS, grace) [symbol] (a touch, IS, delicacy)

[symbol] (grace , IS, rare) [symbol] (delicacy, IS, rare)

Then:

She plays Mozart with a rare grace and delicacy of touch

=(She, plays, Mozar)

[symbol] (She, with, a touch)

[symbol] (a touch, IS, grace) [symbol] (a touch, IS, delicacy)

[symbol] (grace, IS, rare) [symbol] (delicacy, IS, rare).

4. The Specification of the Segmentation and Transformation of the Predicate Calculus-Like form of the Natural Language

Human's thinking reflects the existential status and relation of the outside world. Natural language is the carrier of the thinking. Sentence pattern is the form of organization and structure of human's thinking. The sentence pattern consists of one or several same thinking models(the basic thinking models of thinking).

4.1 The Verb and Verb Phrases of the Segmentation

The verb phrases express the continuous behavior (some can't be segmented).

4.2 The verb phrases related to the continuous behavior

“give sth. to sb.” is a kind of verb phrase for expressing different but continuous behavior. It can't be segmented.

“Give sth. to sb. ” is a kind of similar situation. Essentially, they are all belong to the verb of transference like “ have sth . . . then give sth to . . . ”

We use y to represent the behavior agent and use predicate form to represent the phrase's meaning:

(y gives x to z)

=have (y, z) [symbol] give (y, z)→to(x, z)

4.2.1 Example 1

A villager should empty a bottle of the best wine into the huge barre

The verb phrase “empty WHAT into WHERE” is to express continuous behavior.

The sentence pattern above is(x, empty WHAT into, WHERE)

empty WHAT into WHERE

=(x, empty, WHAT) [symbol] (WHAT, IS into, WHERE)

empty into—injection,
into—in English dictionary: prep. go into, get into, etc.

Which means to be inside of something. However, it can't be the verb according to the English language custom. It can express the nature and result of movement only.

So, the meaning of “into” is: “empty WHAT and WHAT IS into WHERE”.

empty WHAT into WHERE
=(x, empty, WHAT) [symbol] (WHAT, IS into, WHERE)

The above sentence:

A villager should empty a bottle of the best wine into the huge barre

=(a villager, should empty a bottle of the best wine into, the huge barre)

=(a villager, should empty, a bottle of the best wine)→(a bottle of the best wine, IS into, the huge barre)

=(a villager, should empty, ( the wine, IS, a bottle of [symbol] best))→((the wine, IS, a bottle of [symbol] best), )IS into, the huge barre)

To extract the center meaning and get:

(a villager, should empty, the wine)→(the wine, IS into, the huge barre)

4.3 The Verb Phrases Related to Transference

4.3.1 a kind of verb phrases of transference. The receiver of transference is the spatial-time position

Transference is an abstract concept which means the change of the spatial-time position of the same object. It doesn't always mean the movement itself.

Behavior is a process. It contains transference. If the status of the behavior consists of different movement of behavior's main characteristics, then it will generate a series of verbs and verb phrases as mentioned above.

“put . . . on . . . ” is a verb phrase to express the different but continuous movements. It can't be segmented. It also belongs to the model of “have . . . then give . . . to . . . (some spatial-time location)”. This verb phrase's meaning is : have x then put (transfer) x on where. “put . . . on . . . ” show the spatial-time position through “on . . . ”.

We use y to represent the behavior agent and use predicate to represent the phrase meaning: y put x on where

4.3.2 As to the another verb phrase related to the transference, the receiver is object, not the spatial-time position. “give . . . to . . . ” expresses the combination of a series motion. Firstly, you must hold something and then give it to somebody or the other receiver. “have” doesn't mean actually have, it can be virtual. The real meaning is “what you have” “what you control”, etc.

We use y to represent the behavior agent and use predicate to represent the meaning of phrases:

Y give x to z

=have (y, x) [symbol] give (y, x) [symbol] to (x, z)→have (z, x)

“From . . . to . . . ” expresses the transference behavior. It can be identified as a verb phrase. “From . . . ” means “start from here”, “to . . . ” means transfer to somewhere or the time position. It is the expression of spatial-time transference behavior.

We use y to represent the behavior and use predicate to represent the meaning of phrase:

Y comes from x to z

=start from (y, x)→to (y, z)

4.3.3

One kind of verb phrase related to time and space is to express the position of time and space.

Manchester is located between London and Edinburgh.)

“ . . . located between . . . and . . . ”

(x, locate between, y [symbol] z)

“locate” means the position of . . .

Manchester is located between London and Edinburgh

=(Manchester, is located between, London and Edinburgh)
=(Manchester, is located between, London [symbol] Edinburgh)

The verb phrase above can be expressed in the Prolog language:

locate_between(manchester, london, edinburgh)

Or to be concise as:

between(x, y, z)

4.4 How to Segment the Prepositional Phrase

Preposition can be used as predicate in English for solving the problem that most phrases of sentences segmentation may not be classified to the simplest patterns. For example, after/conj at or during a time later than (sth.)

“Ten years after his buying the house, the house become very precious. ”

“after” is used as predicate. The Chinese of “after”is “ [symbol] . . . [symbol] ”. After is used as predicate in Chinese.

Ten years after his buying the house, the house become very precious

=(Ten years , after , his buying the house) [symbol] (the house, become, very precious)
=(Ten years , after , (he, has, buying the house)) [symbol] (the house, become, (precious, IS, very))

=(Ten years , after , (he, has, buying [symbol] the house)) [symbol] (the house, become, (precious, IS, very))

To transform the gerund to verb and get:

=(Ten years, after, (he, has (. . . , bought, the house))) [symbol] (the house, become, (precious, IS, very))

=(Ten years, after, (he, has (he, has bought, the house))) [symbol] (the house, become, (precious, IS, very))

To extract the simplest pattern of the center meaning:

(Ten years, after, buying) [symbol] (he, has, buying) [symbol] (he, has, the house) [symbol] (he, has bought, the house) [symbol] (the house, become, precious)

4.5 The segmentation of sentence and meaning of phrase. The matching of words connected closely. It also has relation with different words' relative position in the sentence. An article is the set of some related words. The set of words is related to the event and the kind of relation. So different events' models are expressed by the related words with stable matching relation.

The position of a concept of the simplest pattern should be an identification of the concept's definition, which to rule the fixed relation of words front and back.

4.6 Transitive and Intransitive Verbs

Clause: “ he gives”

There is no object in “he gives”. That means this clause only expresses the behavior of the subject instead of the entire expression of “give”. This can explain why a verb can be both transitive and intransitive.

4.7 The Structure and Segmentation of the Natural Language Sentence Patterns

There are four basic thinking models and natural language sentence pattern is organized by the basic thinking models. Totally, there are 28 combinations according to permutation and combination.

WBW(“WHAT BE WHAT”)

determiner[x]noun(WHAT₁), BE, determiner[z]noun(WHAT₂).

WDW(“WHAT DO WHAT”)

determiner[x]noun(WHAT₁), determiner[y]verb(DO), determiner[z]noun(WHAT₂).

WBWH(“WHAT BE WHERE”, WHERE means the time-space position)

determiner[x]noun(WHAT), BE, determiner[z]noun(Where).

WBST(“WHAT BE STATE”)

determiner[x]noun(WHAT), BE, determiner[z]adjective(State).

When determiner is the empty set, the sentence is the simplest pattern∘

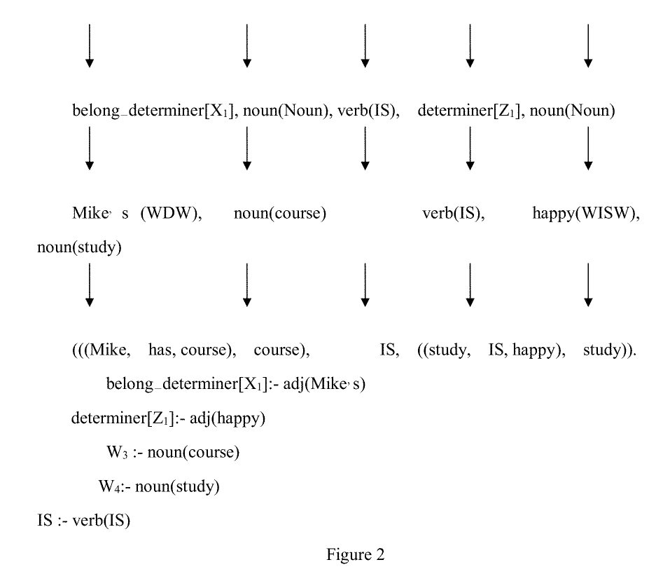

FIG. 2 is the tree structure of a sentence

4.7.1 WDW(“WHAT DO WHAT”)

determiner[x]noun(WHAT₁), determiner[y]verb(DO), determiner[z] noun (WHAT₂).

When determiner is the empty set, the sentence is the simplest pattern.

4.7.1.1 adj[x]noun(WHAT₁), determiner[y]verb (DO), determiner[z]noun(WHAT₂).

determiner[x]=adjective[x], quantifier[x]—[x]is the adjective category matches the noun and expresses some kind of manifestation, nature, relation and quantity. It includes the quantifier.

determiner[x]=adj[X₁, X₂, . . . ]
=(WHAT₁, BE, X₁ [symbol] X₂, . . . )

If there are similar adjectives of attribution in x, like “noun+of”, then they can be changed as:
=(WHAT₁, HAS, X₁) [symbol] (WHAT₁, BE, X₂, . . . )

Example: His beautiful house is located in Lakeshore.

His beautiful house is located in lakeshore

=(His beautiful house, is located in, lakeshore)

=((He, HAS, house) [symbol] (house, BE, beautiful), is located in, lakeshore)
=((He, HAS, house) [symbol] ((house, BE, beautiful)) [symbol] (house, is located in, lakeshore)))

Get:

(He, HAS, house) [symbol] (house, BE, beautiful) [symbol] (house, is located in, lakeshore)

Then:

His beautiful house is located in lakeshore

=(He, HAS, house) [symbol] (house, BE, beautiful) [symbol] (house, is located in, lakeshore).

4. 7. 1. 2 determiner[x]noun(WHAT₁), adverb[y]verb(DO), determiner[z]noun(WHAT₂).

determiner[y]=adverb[y]—[y]is the adverb category matches the verb and expresses degree, characteristics and status.

determiner[y]=adverb[Y₁, Y₂, . . . ]

=(DO, BE, Y₁ [symbol] Y₂, . . . )

Example: He fluently answered foreign guests three questions.

He fluently answered foreign guests three questions

=(He, fluently answered, foreign guests three questions)
=(He, answered(answer, BE, fluently), foreign guests(foreign guests, HAS, three questions) [symbol] questions)

=(He, answered(answer, BE, fluently), foreign guests(foreign guests, HAS, questions) [symbol] questions(questions, BE, three)))

Bottom: (questions, BE, three)

Second floor: (answer, BE, fluently) [symbol] (foreign guests, HAS, three questions)

Top floor: (He, answered, foreign guests) [symbol] (He, answered, questions)
=(He, answered, foreign guests [symbol] questions)

Combine: (He, answered, foreign guests [symbol] questions) [symbol] (answer, BE, fluently) [symbol] (questions, BE, three)

4. 7. 1. 3 determiner[x]noun(WHAT₁), determiner[y]verb(DO), adjective[z]noun(WHAT₂).

determiner[z]=adjective[z], quantifier[z]—[z]is the adjective category matches the noun and expresses manifestation, nature, relation and quantity. It includes quantifier.

The sentence pattern is the completed expression. Lots of sentence pattern can evolved from it. For example, the sentence pattern as follow:

adj[x]noun(WHAT₁), adverb [y]verb(DO), adj[z]noun(WHAT₂).

The great people will create the great achievement.

The great people will create the great achievement

=(The great people, will create, the great achievement)

=(The people(people, BE, great), create(create, BE, will), achievement(achievement, BE, great))

or=(The people(people, BE, great)→(The people, create, achievement(achievement, BE, great))

From the above formula, we can get:

Bottom: (people, BE, great) [symbol] (create, BE, will) [symbol] (achievement, BE, great)

Top floor: (The people, create, achievement)

Combine: (people, BE, great) [symbol] (The people, create, achievement) [symbol] (create, BE, will) [symbol] (achievement, BE, great)

Or

Bottom: (people, BE, great)→(create, BE, will) [symbol] (achievement, BE, great)

Top floor: (The people, create, achievement)

Combine: (people, BE, great)→(The people, create, achievement) [symbol] (create, BE, will) [symbol] (achievement, BE, great)

[WDW(”WHAT DO WHAT″)]

Let's see another complicated English sentence which is called the Garden Path Pattern.

The republicans for whom the condemned senator she voted were trying to cut all benefits for veterans.

The republicans for whom the condemned senator she voted were trying to cut all benefits for veterans

=(The republicans for whom the condemned senator she voted, were trying to cut, all benefits for veterans)

=((The republicans, for, whom the condemned senator she voted), were trying to cut, (all benefits, for, veterans))

=((The republicans(The republicans, for, whom(the condemned senator, IS, the senator(she , voted, the senator)), were trying to cut, all benefits(all benefits, for, veterans)))

=((The republicans(The republicans, for, whom(whom(the senator, IS, condemned), IS, the senator(she , voted, the senator)), were trying to cut, all benefits(all benefits, for, veterans)))

Then we get the sentence meaning:

(The republicans, were trying to cut, all benefits) [symbol] (all benefits, for, veterans) [symbol] (The republicans, for, whom) [symbol] (whom , IS, the senator) [symbol] (she , voted, the senator) [symbol] (the senator, IS, condemned)

The segmentation of the other path:

The republicans for whom the condemned senator she voted were trying to cut all benefits for veterans

=(The republicans for whom the condemned senator she voted, were trying to cut, all benefits for veterans)

=((The republicans, for, whom the condemned senator she voted), were trying to cut, (all benefits, for, veterans)
=(((The republicans, for, whom) [symbol] (whom , IS, the condemned senator she voted)), were trying to cut, (all benefits, for, veterans))
   =((((The republicans, for, whom) [symbol] ((whom , IS, the condemned senator) [symbol] (she, voted, the condemned senator))), were trying to cut, (all benefits, for, veterans))))
      =((((The republicans, for, whom) [symbol] ((whom , IS, the senator) [symbol] (the senator, IS, condemned)) [symbol] ((she, voted, the senator) [symbol] (the senator, IS, condemned))), were trying to cut, (all benefits, for, veterans))))

Combine:

(The republicans, were trying to cut, all benefits) [symbol] (all benefits, for, veterans) [symbol] (The republicans, for, whom) [symbol] (whom , IS, the senator) [symbol] (she, voted, the senator) [symbol] (the senator, IS, condemned)

So the two paths have the same results.

4. 7. 2 (WDW)DW(The front term of “WHAT DO WHAT” is another WDW model)

determiner[x₁ ]noun(WHAT₃), determiner[y₁]verb(DO₁), determiner[z₁]noun(WHAT₄)), determiner[y]verb(DO), determiner[z]noun(WHAT₂).

In the basic model: WHAT₁=determiner[x₁]noun(WHAT₃), determiner[y₁]verb(DO₁), determiner[z₁]noun(WHAT₄)

determiner[x]noun(WHAT₁)=WHAT DO WHAT, for example:

He opened the drawer and took out a dictionary.

He opened the drawer and took out a dictionary

=(he, opens, drawer) [symbol] (he, takes out, dictionary)

This sentence consists of two WHAT DO WHAT models. The time characteristics of (he, opens, drawer) come first. From the time sequence we know: (he, opens, drawer)→(he, takes out, dictionary)

4. 7. 3 WD(WDW)(the back term of “WHAT DO WHAT” is another WDW model)

determiner[x]noun(WHAT₁), determiner[y]verb(DO), (determiner[x₁] noun(WHAT₃), determiner[y₁]verb (DO₁), determiner[z₁]noun(WHAT₄)).

Let's see a complicated sentence conforms to the transformation of the formula above:

I standed under the lamppost that is towering like a slim and graceful magnolia.

The segmentation of this sentence is as follow:

I standed under the lamppost that is towering like a slim and graceful magnolia

=(I, standed under, the lamppost that is towering like a slim and graceful magnolia)
=(I, standed under, the lamppost(the lamppost, is, towering like a slim and graceful magnolia))
   =(I, standed under, the lamppost(the lamppost, is, towering(towering, BE like, a slim and graceful magnolia))
      =(I, standed under, the lamppost(the lamppost, is, towering(towering, BE like, a magnolia(a magnolia, BE, slim and graceful)))
         =(I, standed under, the lamppost(the lamppost, is, towering(towering, BE like, a magnolia(magnolia(magnolia, BE, one), BE, slim and graceful)))

Bottom: (magnolia., 138, slim and graceful) [symbol] (magnolia, BE, one)

Third floor: (towering, BE like, a magnolia)

Second floor: (the lamppost, is, towering)

Top floor: (I, standed under, the lamppost)

To express in Prolog language:

stand_beneath (i, lamp standard), tower (lamp standard), like(lamp standard, magnolia),

is a(magnolia, slim, graceful).

4. 7. 4 (WBWHERE) DW (“WHAT DO WHAT”)

(determiner[x₁]noun(WHAT₃), IS, adjective[z₁]noun(WHAT₄)), determiner [y] verb(DO), determiner [z] noun(WHAT₂).

In the basic model: WHAT₁=determiner[x₁]noun(WHAT₃), IS, determiner[z₁] noun (WHAT₄)

Example: My opinion of the coal trade on that river is, that it may requires talent, but it certainly requires capital.

My opinion of the coal trade on that river is that it may requires talent but it certainly requires capital

=(My opinion of the coal trade on that river, is, that it may requires talent [symbol] but it certainly requires capital)
=(My opinion of the coal trade(My opinion of the coal trade , on, that river), is, it (that it, may requires, talent) [symbol] but it (it, certainly requires, capital))
   =(My opinion(My opinion (My opinion, IS, of the coal trade)) , on, that river), is, it(that it, may requires, talent) [symbol] it((it, IS, but) [symbol] (it, certainly requires, capital)))
      =(My opinion(My opinion(My opinion, IS, of the coal trade)) , on, that river), is, it(that it, requires(requires, IS, may), talent) [symbol] it((it, IS, but) [symbol] (it, requires(requires, IS, certainly), capital)))

Bottom: (requires, IS, may) [symbol] (requires, IS, certainly)

Third floor: (My opinion, IS, of the coal trade)

Second floor: (My opinion, on, that river) [symbol] (that it, requires, talent) [symbol] |(it, requires, capital) [symbol] (it, IS, but)|

Top floor: (My opinion, is, it)

Combine: |(My opinion, is, it) [symbol] (My opinion, IS, of the coal trade) [symbol] (My opinion, on, that river)| [symbol] |(that it, requires, talent) [symbol] (requires, IS, may)| [symbol] |(it, requires, capital) [symbol] (it, IS, but) [symbol] (requires, IS, certainly)|4. 7. 5(WBWHERE)D((WBWHERE)DW)(the front term of “WHAT DO WHAT ” is WBWHERE model, the back term is the self-similar (WBWHERE) DW)

((determiner[x₁]noun(WHAT₃), IS, determiner[z₁]noun(WHAT₄)), verb(DO), (determiner[x₂]noun(WHAT₅), IS, determiner[z₂]noun(WHAT₆)), determiner[y₂]verb(DO₂), determiner[z₂]noun(WHAT₇)).

In the basic model: WHAT₁=determiner[x]noun(WHAT₃), IS, determiner[z₁]noun(WHAT₄)

WHAT₂=((WBWHERE)DW)

Example:

The frosted maple leaves in autumn have turned red, even more red than the flowers in spring.

The frosted maple leaves in autumn have turned red, even more red than the flowers in spring

=((The frosted maple leaves in autumn), have turned, red [symbol] even more red than the flowers in spring))
=((The frosted maple leaves, in, autumn), have turned, red [symbol] (even more red, than, (the flowers in spring)))
   =((The frosted maple leaves, in, autumn), have turned, red [symbol] (even more red, than, (the flowers in spring)))
      =((The frosted maple leaves, in, autumn), have turned, red [symbol] (even more red, than, (the flowers , in, spring)))
         =((The frosted maple leaves, in, autumn), have turned, red [symbol] (even more red, than, (the flowers , in, spring)))

=(The frosted maple leaves, in, autumn) [symbol] (The frosted maple leaves, have turned, red) [symbol] |(The frosted maple leaves, have turned, even more red) [symbol] (even more red, than, the flowers) [symbol] (the flowers, in, spring)|

4. 7. 6 WD(WBW)(the back term of “WHAT DO WHAT” is another WBW model)

determiner[x]noun(WHAT₁), determiner[y]verb(DO), (determiner[x₁] noun(WHAT₃), determiner[y₁]verb (BE), determiner[z₁]noun(WHAT₄)).

The student forgot the solution was in the back of the book

=(The student, forgot, the solution was in the back of the book)

=(The student, forgot, (the solution, was , in the back of the book))
=(The student, forgot, (the solution, was in, (the book, has, the back))

Then we get the sentence meaning:

(The student, forgot, the solution) [symbol] (the solution, was in, the book) [symbol] (the solution , was in, the back) [symbol] (the book, has, the back)

4. 7. 7 WB(WBWHERE), (“WHAT BE WHAT” The back term of BE is WBWHERE model)

(determiner[x₁]noun(WHAT₁), IS, determiner[z₁]noun(WHAT₂)), WHAT₂(determiner[x₂]noun(WHAT₃), prep(p₁), determiner[z₂]noun (WHAT₄)).

In the basic model: WHAT₁=WHAT₁;

WHAT₂=(WBWHERE)

Example: Katoomba is the most visited town in the Blue Mountains.

Katoomba is the most visited town in the Blue Mountains
=(Katoomba, is, the most visited town in the Blue Mountains.)
   =(Katoomba, is, the town(the most visited town, in, the Blue Mountains.)
      =(Katoomba, is, the town(the town(the town, IS, most visited), in, the Blue Mountains.)
         =(Katoomba, is, the town) [symbol] (the town, in, the Blue Mountains.) [symbol] (the town, IS, most visited)

4. 7. 8 To transform some special natural language to the predicate calculus-like form

Example 1 Jack is taller than Jill (is)
Jack is taller than Jill

=(Jack, is, taller than Jill)
=(Jack, is, (taller, than, Jill))
   =(Jack, is, taller) [symbol] (taller, than, Jill)

Example 2 Jack is the taller of the two children

Jack is the taller of the two children

=(Jack, is, the taller of the two children)

=(Jack, is, (the taller, in, the two children))
=(Jack, is, the taller) [symbol] (the taller, in, the two children)

Example 3 As time went on, things got worse and worse

As time went on, things got worse and worse
=(As)(time, went on)→(things, got, worse and worse)

Example 4 As you go farther north, so the winters become longer and more severe

As you go farther north, so the winters become longer and more severe

=(As)(you, go, farther north)→(so)(the winters, become, longer and more severe)

The different expression of the similar sentence meaning; polite and familiar literary from:

\textcircled{1}Petr's old woman hit the roof when he came home with that doll from the disco. (very familiar)

\textcircled{2}Peter's wife was very angry when he came home with the girl from the discotheque. common core)

These two sentences are in the same pattern. Only some words in the corresponding position are different.

hit the roof=very angry

that doll=the girl

\textcircled{1}Petr's old woman hit the roof when he came home with that doll from the disco

=(Petr's old woman, hit, the roof) [symbol] (when)(he, came, home) [symbol] (he, with, that doll from the disco)

=(Petr's old woman, hit, the roof) [symbol] (when)(he, came, home) [symbol] (he, with, that doll (that doll, from, the disco))

=(Petr's old woman, hit, the roof) [symbol] (when)(he, came, home) [symbol] (he, with, that doll [symbol] (that doll, from, the disco)

\textcircled{2}Peter's wife was very angry when he came home with the girl from the discotheque

=(Petr's wife, was, very angry) [symbol] (when)(he, came, home) [symbol] (he, with, that girl from the discotheque)

=(Petr's wife, was, very angry) [symbol] (when)(he, came, home) [symbol] (he, with, that girl [symbol] (that girl, from, the discotheque)

To replace the general subject with the lead word “there”. The replaced general subject is moved to the back of BE.

\textcircled{1} Something must be wrong.

\textcircled{2} There must be something wrong.

\textcircled{1} Something must be wrong

=(Something, must be, wrong)

\textcircled{2}There must be something wrong

=(There, must be, something wrong)

=(There, must be, (something, must be, wrong))
=(There, must be, \textcircled{1})

Too many people are trying to buy houses.

There are too many people trying to buy houses.

\textcircled{1} Too many people are trying to buy houses

=(Too many people, are trying to buy, houses)
=(people(people, IS, Too many), are trying [symbol] to buy, houses)
   =(people, are trying [symbol] to buy, houses) [symbol] (people, IS, Too many)

\textcircled{2}There are too many people trying to buy houses.

=(There, are, too many people trying to buy houses)
=(There, are, (too many people, are trying to buy, houses))
   =(There, are, (people, are trying [symbol] to buy, houses) [symbol] (people, IS, Too many))

=(There, are, \textcircled{1})

Let's see the other complicated sentence pattern:

\textcircled{1} One day the poor have nothing left to eat but the rich.

\textcircled{2} I already regret choosing to carry a sign around all day.
\textcircled{3} They drove downhill to the college.

\textcircled{2} One day the poor have nothing left to eat but the rich

=(It, IS, one day)→(the poor, have nothing left to eat but, the rich)
=(It, IS, one day)→(the poor, have, nothing) [symbol] (nothing, left [symbol] to eat) [symbol] (nothing, IS but, the rich))

\textcircled{2} I already regret choosing to carry a sign around all day

=(I, already regret, choosing to carry a sign around all day)
=(I, already regret, choosing(choosing, IS, to carry a sign around all day))
   =(I, already regret, choosing(choosing, IS, (( . . . , carry , a sign), IS around, all day)))
      =(I, already regret, choosing(choosing, IS, ((I, carry , a sign), IS, around, all day)))

\textcircled{3} They drove downhill to the college

=(They, drove downhill to, the college)

=(They, drove [symbol] downhill [symbol] to, the college)

=(They, drove (drove, IS downhill [symbol] to, the college))

=(They, drove [symbol] (They, downhill [symbol] to, the college))

Some sentences which contain the assumption clause:

\textcircled{1} It's time you were in bed.

It's time you were in bed

=(It's time you were in bed)
=(It's time [symbol] (It, is , you were in bed)
   =(It, is , time) [symbol] (It, is , (you , were in, bed))

\textcircled{2} It's as though he were poor.

It's as though he were poor

=(It, is, as though) [symbol] (It, is, (he, were, poor))

=(It, is, as though) [symbol] (It, is, (he, were, poor))

=(It, is, as though) [symbol] (It, is, (he, were, poor)) [symbol] (he, were, poor)
=(It, is, as though) [symbol] (It, is, HE)) [symbol] (It, is, poor)) [symbol] (he, were, poor)

4.8 Complete and Automatic Transformation from Natural Language Predicate Calculus-Like Form to Predicate Calculus

The segmented predicate calculus-like form completely corresponds to the predicate calculus. To transform both of them through the machine automatically. Then to express the sentence pattern in the form of predicate through the Prolog programming language on the basis of programming algorithm and description.

[Examples] To transform the following sentences to the predicate calculus:

\textcircled{1} People whoever passes the the examination of history and wins the lottery is happy.

∀x(pass(x, history) [symbol] win(x, lottery)→happy(x))

S₁=People whoever passes the examination of history and wins the lottery is happy.

=(People whoever passes the examination of history and lottery , is , happy)
=(whoever(passes the examination of history and wins the lottery), is , happy)
=(∀people((people, passes, the examination of history) [symbol] (people, wins, lottery), is, happy)

=(∀people(passes(people, the examination of history) [symbol] wins(people, lottery)), is , happy(people))

=(∀people(passes(people, (examination, is , history)) [symbol] wins(people, lottery)), is, happy(people))

=(∀people(passes(people, history) [symbol] wins(people, lottery)), is, happy(people))

=(∀people (passes(people, history) [symbol] wins(people, lottery)), is, happy(people))

=(∀x(pass, history) [symbol] win(x, lottery), is, happy(x))

=∀x(pass(x, history) [symbol] win(x, lottery)→happy(x))

Then we can have the basic central sentence meaning:

IF(people, pass, the examination of history) [symbol] (people, win, lottery) THEN (people, is , happy)

This formulation consists of three terms and transforms to predicate calculus directly.

Sentence(people, is, happy) :-WDW(people, pass, the examination), WDW(people, win, lottery).

WDW(people, pass, the examination):—

WDW(people, win, lottery):—

Three basic sentences above can be used to response this sentence.

Note: (examination, is, history) means that “examination” equals to “history”. For the conciseness, “examination” can be eliminated. And “people” can be replaced with the variate X.

S₁=∀x(pass(x, history exam) [symbol] win(x, lottery)→happy(x))
=∀x(pass(x, history_exam) [symbol] win(x, lottery)→happy(x))

To compare the above formula:

∀x(pass(x, history) [symbol] win(x, lottery)→happy(x))

Through the planning and description, the sentence pattern will be changed to the predicate form on the basis of Prolog programming language:

The initial status of the sentence pattern is:

Start=People whoever passes the the examination of history and wins the lottery is happy.

=(∀people(pass(people, (exam, is, history)) [symbol] win(people, lottery)), is, happy)
[∀nounphrase(determiner[x], noun), BE, determiner(x)]

goal=[∀x(pass(x, history) [symbol] win(x, lottery)→happy(x))]

The transformation procedure is as follow:

1. transform(add(whole_curves), out_of_whole_curves(universal quantification∀x), (add(curves₁), put_in_curves₁(noun), put_in_curves_{‘}(comma), add_in_curves₁(BE), add_in_curves₁(comma), put_in_curves₁(determiner[x]), add(comma), change(BE, implication→), add(comma), determiner(x))

2. transform(add(whole_curves), out_of_whole_curves(universal quantification∀x), (add(curves₁)(add(curves₂), put_in_curves₂(noun), add_in_curves₂(comma), put_in_curves₂(DO₁), add_in_curves₂(comma), (put_in_curves₂(determiner X₁[x]), add(conjunction [symbol] ), add(curves₃), put_in_curves₃(noun), add_in_curves₃(comma), (put_in_curves₃(DO₂), add_in_curves₃(comma), (put_in_curves₃(determiner X₂[x])), add_in_whole_curves(comma), (change(BE, implication→), determiner X₃(x))

3. transform (add(whole curves), out_of_curves(universal quantification∀x), (add(curves₁), (add(curves₂), out_of_curves₂(DO₁), put_in_curves₂(noun), add_in_curves₂(comma), (put_in_curves₂(determiner (X₁)[x]), add(conjunction [symbol] ), add(curves₃), out_of_curves₃(DO₂), put_in_curves₃(noun), add_in_curves₃(comma), (put_in_curves₃(determiner (X₂)[x])), add_in_whole_curves(comma), (change(BE, implication→), determiner(X₃)(x))

4. transform (add(whole curves), out_of_curves(universal quantification∀x), (curves(curves₁), (curves(curves₂), out_of_curves₂(DO₁), change_to(x), in _curves₂(comma), (determiner(X₁), conjunction( [symbol] ), curves(curves₃), out_of _curves₃(DO₂), change_to(x), in_curves₃(comma), (determiner(X₂)), (implication(→), determiner (X₃)(x))

4.9 The Automatic Reasoning of the Natural Language Predicate Calculus-Like Form

[Living Examples] The subjects for expressing “ events” contains two situations. One is behavior event, the other is some kind of relation formulation. As to the subjects for expressing “events”, they usually exist as independent clauses.

4.9.1 The Automatic Reasoning Calculus Model of Natural Language Predicate Calculus-Like Form

The automatic reasoning and association of predicate calculus-like form transformed from the natural language

The set of simplest thinking models consists of three terms after the segmentation. To match and identify through searching and realize automatic reasoning and association by recursion and substitution. Association means the backtracking and spread of gestalt structure and the connection of different concepts generated by backtracking and spreading.

After the sentences of paragraph been segmented, the paragraph becomes a set of several sequences and each sequence consists of three terms. The sequence consists of the simplest three terms stored in register address.

The reasoning calculus model on the basis of the natural language predicate calculus-like form:

1. According to the principle of time priority, to use the third term of the first sequence of the first sentence minus the first term of the first sequence of the secondary sentence. If the result is zero and second term of the first sequence of the first sentence minus the second term of the second sequence of the secondary sentence equals zero, then replace the third term of the first sequence of the first sentence with the first term of the second sequence of the secondary sentence. The new first sequence of the first sentence is established.

1.1 If there is no such result above, then use the third term of the first sequence of the first sentence minus the first term of the third sequence of the secondary two sentences. If the result is zero and the second term of the first sequence of the first sentence minus the second term of the third sequence of the secondary two sentences equals zero, then replace the third term of the first sequence of the first sentence with the first term of the third sequence of the secondary sentences. The new first sequence of the first sentence is established;

2. To use the third term of the first sequence minus the first term of the sequence which has successfully completed step 1. If the result is zero and the second term of the first sequence minus the second term of the secondary sequence which has successfully completed step 1. equals zero, then replace the third term of the first sequence with the first term of the secondary sequence which has successfully completed step 1.

3. To repeat the procedure above until it can't be done. Then terminate the procedure and output the new first sequence(this is the reasoning result).

4. If the selected sequence can't through the procedure above, then use the secondary sequence to do the procedure above.

5. The result shall be outputted whether there is a reasoning result or not. The calculus model for the non-complete logical reasoning and judgment

1. To replace kind with individual. Then the individual becomes the assignment of the variable kind. Or to replace individual with kind. This depends on the demand of reasoning target. So does the relation between the terminal abstract concepts(like the paired and polarized abstract concepts: order and disorder, good and bad) and the specific concepts which the abstract concepts include.

2. If the clause contradicts to the expression of sentence main structure, then the sentence is invalid.

3. The behavior agents with the cause and effect relation chain of the same behavior chain can replace the latter with the former under the order of cause and effect(it depends on the uniqueness limited by the space and time of the cause and effect relation). In the substitution calculation, if the entire kind concept W includes several same individual concepts(W₁, W₂, . . . wn), then W₁, W₂, . . . , wn equals to W respectively and can replace W(the equivalence relation between full name concepts and specific concepts).

4. WHAT₁ BE WHAT₂ equals to WHAT₂ BE WHAT₁.

5. In the model “WHAT₁ Do WHAT₂”, Do equals to WHAT₂.

6. As the third term of the sentence, WⱼDWⱼ₊₁ can be drew independently with entire meaning. It can create new sentence through the combination with other WDW. And as the third term, WⱼD can be canceled and Wⱼ₊₁ shall be saved only. The sentence will be reduced to then central meaning sentence.

7. To eliminate the determinative expression of DO which once was segmented into one of the four basic thinking models. And WHAT of the last DO of the same sentence shall be saved. If WHAT belongs to BE kind, then the two sides of BE equals to each other and become two simplified sentences.

8. Three terms of the basic model which is fully segmented , except BE, can replace each other in the same situation. The same word of each sentence can be replaced with an equivalent word.

[Living Examples]:

\textcircled{1} The membrane is a kind of the translucent cover material used for construction.

\textcircled{2} Covered material focuses on the effect of light and color.

\textcircled{3} Translucent material that focuses on the effect of light and color is adapted to the combination with LED light.

\textcircled{4} Come to conclusion through reasoning:

Membrane is adapted to the combination with LED light

The reasoning process is as follow:

\textcircled{1} The membrane is the translucent cover material used for construction

=(The membrane, is, (a kind of the translucent cover material used for construction))
=(The membrane, is, the material((the material, BE, translucent [symbol] covered) [symbol] (the material, BE, a kind) [symbol] (the material, used for, construction)))
   =(The membrane, is, the material) [symbol] (The membrane, BE, translucent [symbol] covered) [symbol] (The membrane, BE, a kind) [symbol] (The membrane, used for, construction)

=(W₁, is, W_{2A}) [symbol] ((W₁, is, State₁ [symbol] State₂) [symbol] ((W₁, is, K₁) [symbol] (W₁, D₁, W₃)))

To extract the entire basic thinking of the formula:

(W₁, is, State₁ [symbol] State₂) [symbol] (W₁, D₁, W₃),

[symbol]

(The membrane, is, translucent [symbol] cover) [symbol] (The membrane, used for, construction)

W₁(The membrane)

W₂(translucent cover material used for construction)

W_{2A}(the material)

W₃(construction)

D₁(be used for)

State₁(translucent)

State₂(covered)

W_{2A} includes W₁, (W_{2A}, contain, W₁)∘

K₁(a kind)

\textcircled{2} Covered material focuses on the effect of light and color

=(Covered material, focuses on, the effect of light and color)
=((material, BE, Covered), focuses on, light and color(light and color, HAS, the effect))
   =(material, focuses on, light and color)A(material, BE, Covered) [symbol] (light and color, HAS, the effect)

(material, focuses on, light and color)=(W_{2A}, D₂, W_{4A})

W₄(the effect of light and color)

W_{4A}(light and color)

W₅(the effect)

D₂(focuse on)

\textcircled{3} Translucent material that focuses on the effect of light and color is adapted to the combination with LED light

=(Translucent material that focuses on the effect of light and color, is adapted to the combination with, LED light)

=(material((material, BE, that [symbol] translucent) [symbol] (that, focused on, the effect of light and color)), is adapted to the combination with, LED light)

=(material((material, BE, material [symbol] translucent) [symbol] (material, focused on, the effect of light and color)), is adapted to the combination with, LED light)

=(material, is adapted to the combination with, LED light)A(material,BE, translucent) A(material, BE, material) [symbol] (material, focused on, the effect of light and color)
(W_{2A}, D₃, W₆) [symbol] (W_{2A}, BE, State₁) [symbol] (W_{2A}, BE, W_{2A}) [symbol] (W_{2A}, D₂, W₄)

W₆(LED light)

D₃(is adapted to the combination with)

\textcircled{4} Reasoning concluded:

Membrane is adapted to the combination with LED light.

By

\textcircled{3}, we get:

(W_{2A}, D₃, W₆)

since W_{2A} contains W₁, that is(W_{2A}, contain, W₁), to substitute and get:

(W₁, D₃, W₆)

=(The membrane, is adapted to the combination with, LED light)

To backtrack and generate:

The membrane is adapted to the combination with LED light.

Get the reasoning conclusion.

[Living Example]

The following story is from N. Wirth's (1976) Algorithms [symbol] data structures=programs (quoted from Artificial Intelligence Structures and Strategies for Complex Problem Solving(Sixth Edition, P78)

I married a widow(let's call her W)who has a grown-up daughter(call her D). My father (F), who visited us quite often, fell in love with my step-daugther and married her. Hence my father became my son-in-law and my step-daughter became my mother. Some months later, my wife gave birth to a son (S₁), who became the brother-in-law of my father, as well as my uncle. The wife of my father, that is, my step-daugther, also had a son (S₂).

I married a widow(let's call her W)who has a grown-up daughter(call her D). My father (F), who visited us quite often, fell in love with my step-daugther and married her. Hence my father became my son-in-law and my step-daughter became my mother. Some months later, my wife gave birth to a son (S₁), who became the brother-in-law of my father, as well as my uncle. The wife of my father, that is, my step-daugther, also had a son (S₂).

=| (I, married, a widow W) [symbol] (who W, has, a grown-up daughter D) | [symbol] (My father F, visited . . . quite often, us) [symbol] (My father F, fell in love with, my step-daugther D) [symbol] (my father F, married, her D)→Hence (my father F, became, my son-in-law) [symbol] (my step-daughter D, became, my mother D) [symbol] Some months later (my wife W, gave, birth) [symbol] (birth, to, a son S₁)→| (who S₁, became, the brother-in-law of my father [symbol] as well as my uncle)| [symbol] (The wife of my father D, is, my step-daugther D) [symbol] (The wife of my father D, also had, a son S₂) [symbol] (my step-daugther D, also had, a son S₂)

1 by| (I, married, a widow W) [symbol] (who, has, a grown-up daughter D) |, get

2 (I, have, my step-daugther D) . . . It is not existed in the original text. It is provided by the knowledge database.

3 by (my step-daugther D, also had, a son S₂) , get

4 (I, am, S_{2′} grandfather) . . . It is not existed in the original text. It is provided by the knowledge database.

5 (my step-daughter D, became, my mother D), that is

6 my step-daughter D=my mother D, to substitute and get

7 (my mother D, also had, a son S₂) , get

8 (I, am, S_{2′} brother) . . . It is not existed in the original text. It is provided by the knowledge database.

9 S₂ equals to (S_{2′} brother) under the seniority . . . It is not existed in the original text. It is provided by the knowledge database.

10 S_{2′} brother=S₂, to substitute and get

11 (I, am, S_{2′} grandfather)

12 =(I, am, (S_{2′} brother) grandfather)

13 and

14 (I, am, S_{2′} brother)

15 =(I=S_{2′} brother)

16 to substitute and get

17 (I, am, S_{2′} grandfather)

18 =(I, am, (S_{2′} brother) grandfather)

19 =(I, am, (I) grandfather)

20 I am my grandfather.

After the natural language is segmented, we will implement the reasoning through the substitution of same words and the substitution of full-name and monomer under the help of this invention's methods.

Example 1: rational analysis of paradox

An example of a paradox, the painter

A town house painter, and everyone all has a own house,

the painter regulation, and only in the town, the painter paint only those house who do not paint themselves.

Question: Should the painter give himself a painting?

S₁=(A town house painter and everyone, all has, a own house)
=(A town) [symbol] (house painter [symbol] everyone, all has, a own house)

=(A town) [symbol] (house painter [symbol] everyone, all has, house(house, IS, a [symbol] own))
=(A town) [symbol] (house painter, has, house) [symbol] (everyone, all has, house) [symbol] (house, IS, a [symbol] own)

S₂=the painter regulation, and only in the town, the painter paint only those house who do not paint themselves
=((the painter regulation) [symbol] (only in the town), (the painter, paint only, those house who do not paint themselves))

=((the painter regulation) [symbol] (only in the town), (the painter, paint only, those house (who, do not paint, themselves))

=((the painter regulation) [symbol] (only in the town), (the painter, paint only, those house) [symbol] (those house, do not paint, themselves) [symbol] (who, do not paint, themselves))

=(the painter regulation) [symbol] (only in the town) [symbol] (the painter, paint only, those house) [symbol] (those house, do not paint, themselves) [symbol] (who, do not paint, themselves)

S₁=(A town) [symbol] (house painter, has, house) [symbol] (everyone, all has, house) [symbol] (house, IS, a [symbol] own)

S₂=(the painter regulation) [symbol] (only in the town) [symbol] (the painter, paint only, those house) [symbol] (those house, do not paint, themselves) [symbol] (who, do not paint, themselves)
(the painter, paint only, those house) [symbol] (those house, do not paint, themselves), after the recursion substitution:(the painter, do not paint, themselves) . . . (1)

S₃=(the painter, give, himself a painting)
=(the painter, give, himself [symbol] a painting)

S₃=(the painter, give, himself) . . . (2)
[symbol] (the painter, give, a painting)

(1) contradicts to(2), thus, (the painter, give, himself) can't be established∘The choice can only be other(the painter, give, a painting)∘
Example 2: the reasoning analysis of paradox

An example of a paradox, the barber
A village only one barber, and the villagers all need a haircut,

the barber regulation, and only in the village the barber shave only those men who do not shave themselves.

Question: Should the barber give himself a haircut?

S₁=(A village, only one barber and the villagers, all need, a haircut)
=(A village) [symbol] (only one barber and the villagers, all need, a haircut)

=(A village) [symbol] ((barber(barber, only, one) [symbol] the villagers), all need, a haircut)
=(A village) [symbol] (((barber, need, a haircut) [symbol] (barber, only, one)) [symbol] (the villagers, all need, a haircut))

=(A village) [symbol] |(barber, need, a haircut) [symbol] (barber, only, one)| [symbol] (the villagers, all need, a haircut)

S₂=(the barber regulation, and only in the village the barber, shave only, those men who do not shave themselves)

=(the barber regulation) [symbol] (only in the village the barber, shave only, those men who do not shave themselves)
=(the barber regulation) [symbol] ((the barber, only in, the village) the barber, shave only, those men(who, do not shave, themselves))
   =(the barber regulation) [symbol] ((the barber, shave only, those men) [symbol] (those men, do not shave, themselves) [symbol] (the barber, only in, the village))
   =(the barber regulation) [symbol] (the barber, shave only, those men) [symbol] (those men, do not shave, themselves) [symbol] (the barber, only in, the village)

S₁=(A village) [symbol] |(barber, need, a haircut) [symbol] (barber, only, one)| [symbol] (the villagers, all need, a haircut)

S₂=(the barber regulation) [symbol] (the barber, shave only, those men) [symbol] (those men, do not shave, themselves) [symbol] (the barber, only in, the village)

(the barber, shave only, those men) [symbol] (those men, do not shave, themselves), the recursion reasoning can't be done, then we get:

(the barber, shave only, those men) . . . (1)

[symbol] (those men, do not shave, themselves)

S₃=(the barber, give, himself a haircut)
=(the barber, give, himself [symbol] a haircut)
   =(the barber, give, himself) . . . (2)

[symbol] (the barber, give, a haircut)

The simplest expression (1) and (2) contradict to each other. So there is no solution.

It seems like that Example 2 is similar to Example 1. They are , however, quite different from each other.

[Examples of reasoning]

If the past participle is used to be the attribute of the subject head word, then the sentence equals to a attributive clause with passive voice since the attribute and the word it modified are in the passive relation.
Most of the people invited to the party were famous scientists. And
Most of the artists invited to the party were from South Africa.

The new sentence with the related meaning will be generated from them.

\textcircled{1} Most of the people invited to the party were famous scientists

=(Most of the people invited to the party, were, famous scientists)
=((Most of the people, IS, invited to the party), were, famous scientists)

=(Most of the people, IS, invited to the party) [symbol] (Most of the people, were, famous scientists)

\textcircled{2} Most of the artists invited to the party were from South Africa.

=((Most of the artists, IS, invited to the party), were, from South Africa)
=(Most of the artists, IS, invited to the party) [symbol] (Most of the artists, were, from South Africa)

The first central sentence(Most of the X, IS, invited to the party)of the two sentences are the same, since artist E people(artist belongs to the category of people), thus, were can be replaced with may, artists of \textcircled{2} can be replaced with people, most can be replaced with some, and generate automatically

\textcircled{3}(Some of the people, BE, invited to the party) [symbol] (Some of the people, may be, from South Africa)

To backtrack and generate sentence

Some of the people invited to the party may be from South Africa.

Output.

Note: This example is the sentence generated by substitution under the condition that the concepts of the same category have the same central sentence pattern.

5. How to Generate Sentence?

The generation of sentence is to add WHAT—noun or pronominal subject and DO—the determinate attributes of verbal predicate on the basis of the simplest basic thinking model. To set determiner[x] as the set of determiners. And to combine the set of determiners with WHAT and DO. Then the four basic thinking models form the natural language sentence pattern. There are only three terms of words in the four simplest thinking models. There is no other basic thinking models. And the four basic models all have entire sentence meaning which can be drew and used directly. Thus, it is convenient to reason, draw the questions from original sentence and create the answering sentence.

WDW sentence is the description of events. The basic thinking model expresses all active situations. Besides, there will be passive situations happen simultaneously. Different behavioral agents may have similar behavior or quite different behavior, for example the difference between the self-acting body like human, animal and machine

This reflects in the difference of matching.

5.2 The Generation of Sentence

The generation of sentence is the reversed operation of the segmentation of sentence. It is a backtracking method. Since our knowledge database consists of the simplest pattern(the predicate calculus-like form), thus we can conveniently output the sentences which reorganized by the knowledge.

Through the combination of the same words or synonyms or affiliated words, the recursion and syncretism will be done after such replacement of words. Finally, the natural language can be outputted through the operation of backtracking.

The backtracking process of sentence segmentation is the generation process of new sentences. On the basis of sentence segmentation, new set of simplest thinking model will be generated under the logical reasoning process completed by the replacement of the same words. A new sentence will be outputted by doing backtracking—the reversed segmentation(the same as the result of human logical thinking).

5.2.1 The Compound Sentence Consists of the Same Inherent Elements of the Sentence

[Living Example] The compound sentence consists of the same inherent elements of the simplest pattern or simple sentence is the sentence generated by backtracking and generalization through inverse segmentation. Note: Each term of the generalization sentence pattern may be phrase or sentence. It is also a learning method to generalize the expression transformed from the learned natural language predicate calculus.

5.2.3 To Generate the Related Meanings Sentence by Using the Attribution Relation of Subject Head Word

If the attribute of the subject head word is in the past participle, then the reason is that this attribute and the word it modified are in the passive relation which equals to a attributive clause in the passive voice.

6. The Segmentation and Understanding of the Natural Language Predicate Calculus-Like Form of the Entire Chapter

6.1 The Segmentation and Understanding of the Entire Chapter

In the same behavioral chain, the latter behavioral agent can be replaced with the former behavioral agent of the same cause and effect chain under the cause and effect order. Since “tension” caused by “interaction” and “impulsion” caused by “tension”, so the initial cause is “interaction”.

Thus, “tension” as the latter can be replaced with “interaction” as the former under the order of cause and effect chain. They all belong to the WDW model. “Interaction” as the latter can be replaced with “many people” in the same way.

This is also the understanding of the paragraph's central meaning of natural language and the result of automatic reasoning.

Note: “Here” of the phrase “bring . . . here . . . ” is the word for expressing space direction, which means “bring . . . to the behavioral agent”. This is contradicted to the “to” of the phrase “ bring . . . to . . . ”. Similarly, “on” and “under” express the “surface” and “phenomenon”13 external manifestation(on) and internal situation(under). For example, “on this issue, . . . ” and “under this situation, . . . ”.

Just like the above example, the omitted behavioral agent of the latter sentence is the same as the former sentence on the basis of the characteristics of human thinking.

Calculus Model of the Recognition of Semantics (Metaphor)

(1) To conclude the semantics as some kind of abstract meaning model

(2) To use this model automatically as the replacement. To do the simplest basic thinking model expression of the original sentence.

(3) To backtrack successively and reduce the entire sentence or paragraph to some certain or a group of abstract meaning models which contain the cause and effect relation.

(4) The abstract meaning model consists of a group of simplest basic thinking models which contain the cause and effect relation.

(5) The semantics net related to the theme of statement consists of an article or one or several paragraphs.

(6) The understanding of the natural language is the matching of present sentences and the set of some model's rules(namely, template).

[Living Example] The human beings' social units and entire general rules expressed on the basis of full and automatic transformation of the the natural language predicate calculus-like form

The social units and entire general rules:

If there is a negative constrained appoint that the individual should give something for the whole social target and an individual hopes to benefit from the target without giving anything, then the individual may avoid to giving something that each individual should undertake for the realization of the target. If each individual's behaviors are contrary to the target, then the sum effects of individuals are contrary to the target.

When there are lots of individuals, one individual may guess that the whole social target will be achieved even if his behaviors are contrary to the target since there are lots of individuals. Thus the individual implements his thoughts. His thoughts may be the same as the majority or all individuals' guess and behaviors. Then the situation above will be realized.

To set x as the set of individuals and p as the set of whole social target
∀x useful(P, x)—“it is useful for both x and p”
∀x freely_give(x, P)—“all x should give something to p under non-supervised constraint”
∀x same give_for P(x)→∀x obtain from P(x)—“each x should give the same thing to p and each x can benefit from p”
∀x(Ey not same give_for P(x)→like(x, y))—“if there is a y who doesn't give the same thing , the the other x may do the same like y”
∀x(like(x, y)→∀x obtain from P(x)—“ if all x do the same thing like y, then all x can't achieve the whole target ”

Note: x, y=What, variable x, y may be the single concept or one sentence statement, etc.

The social principles above can applied to the following essay for the understanding of the natural language (after the formalization of the essay, the related conclusion (the inference of the essay's meaning) will be generated, that's to extract the head meaning of the story):

If there is a negative constrained appoint that the individual should give something for the whole social target and an individual hopes to benefit from the target without giving anything, then the individual may avoid to giving something that each individual should undertake for the realization of the target. If each individual's behaviors are contrary to the target, then the sum effects of individuals are contrary to the target.

7. The Segmentation and Machine Translation of the Natural Language Predicate Calculus-Like Form

7.1 The Automatic Translation Calculus Model of the Natural Language Predicate Calculus-Like Form:

(1) The segmentation of sentences

The basic translation sentences are based on the simplest pattern of the basic thinking models and added with the sentences of each word's determiners. This sentence pattern is the same in both English and Chinese.

(2) The attributes of behavior effect of the behavioral agent shall be determined specifically in English and omitted in Chinese.

(3) The abstract meaning of “existence” shall be expressed in English and omitted in Chinese.

(4) “WHAT₁BE of WHAT₂” equals to “WHAT₁ HAS WHAT₂”

(5) There are many abotic behavioral agents in English while less in Chinese. Mostly, the abotic behavioral agents appeared as metaphor and are quite different in the choice of words.

(6) “It ” appears a lot as the behavioral agent in English. For the balance of the sentence, the clause is usually put in the end of the sentence and “it” is put in the initial as the subject. During the process of transformation, the passive voice shall be replaced with active voice.

(7) To replace the translation words of the segmented simplest pattern and generate the translation sentence through backtracking.

The two central sentences completely correspond to each other by comparing Chinese with English.

Note: “condemn severely” can be segmented into “condemn(condemning, IS, severe)”

8. The Natural Language Expression of the Mathematical Machine Thinking

The calculus model of the mathematical problem-solving proceeded under the natural language predicate calculus-like form:

1. To establish the problem-solving template. The template should include the synonyms. The words in different position of the simplest sentence pattern should be set as the word list [X] consists of the single synonyms or synonymous determiners. The template corresponds to all natural sentences with the same meaning;

2. To segment the mathematical problems expressed in words into the predicate calculus-like form;

3. To realize the problem-solving procedure by doing a series of recursion and substitution on the basis of the same words correspond to the problem-solving template;

4. To calculate through the calculation procedure;

5. To do the backtracking automatically and output the generated sentences.

9. The Invention'S Expression of Metaphor, Association and Creative Thinking

9.1 The Expression of Metaphor

The gestalt structure dimension of concept is the set of concept's characteristics and metaphor function. The basic characteristic is the meta-concept which includes physical characteristics (the determination of time and space, location relation, mode of action, etc.), measurement of degree(size, strength, hardness, soft, aggregation, separation, geometrical relation) and the interrelation model (cause and effect, tendency, continuance and interruption).

The concept's gestalt structure dimension, as the structure to express “gestalt” significance, is to express the complete relation of objects and events and the structure after the morphological manifestation. “Dimension” is the factor constitutes the gestalt structure. “Dimension” constitutes the gestalt with specific meaning. The gestalt structure of things and their dimension can be analyzed, concluded and extracted in different abstract levels as needed. This to understand and recognize things in different abstract levels. Thus it's to constitute the basic of creative thinking.

According to this invention, firstly to formalize the information and knowledge on the basis of gestalt structure dimension and combine them with the mechanism. And on the basis of formalization, to realize the thinking process and result of association through combination and transformation. Generally, most words in the sentence have extended meaning. And if to express this with the gestalt structure dimension, the gestalt structure dimension of the “word” is just the context of the “word”. The uniqueness can be seen from the following analysis on the sentence “I am reading book” through BNF(Bachus-Naur Form).

The metaphorical reasoning of the predicate calculus-like form

The metaphorical reasoning is the generated way of association and metaphor.

In the relation of metaphor's source body and target body, the composed elements are the similar gestalt structure dimension. The feasible pattern problem of innovative thinking can be solved by finding metaphor's operation pattern which can be decomposed automatically. Innovation can be achieved by using the partial similarity of gestalt structure dimension. From the point of mind, the innovation is the result of metaphor.

We explain it through one of the interrelation symbols—the “aggregation” gestalt structure dimension of morphology:

The relation symbol of “aggregation”: \textcircled{1} more than 2 basic elements; \textcircled{2}inter-dependent; \textcircled{3} tend of opposite morphology; \textcircled{4} complementarity; \textcircled{5} similarity \textcircled{6} ordering

Obviously, straight line morphology doesn't have the characteristics of “aggregation”. Only the curved river has the function of “ vitality aggregation” and this has been recorded in the geomantic theories of Chinese ancient architecture. And we explain it by the gestalt structure dimension of the emotional word “love”:

1) the gestalt structure dimension of “love”: \textcircled{1} Non-equilibrium, which means “love” is tendentious and biased. \textcircled{2} Control relation, which means the influence on mind and it has constraint effect. \textcircled{3} Subject and object (actor and passives). And the actor is the most affected one of the control of “love”. \textcircled{4} Interaction relation, which means to pay and get reward simultaneously. “Love ” is to pay (mental or behavioral) and this will make the actor meet his or her wish at the same time. This is to realize the wish of paying love. \textcircled{5} In the stimulus-response relation, “love” firstly appears as the tendency of the reception of stimulus and then causes the stimulating experience of physiological and psychological emotion. That is to enter the state of “love”. This tendency of the reception of stimulus is called “attitude”.

2) “Hate” contradicts to love but they are same in partial dimension. “Hate”, however, is different in \textcircled{5} since it has the tendency of excluding the stimulation.

“A” consists of a series of middle process and things named after the concepts of symbol system. For example, a house, a machine, etc. One thing can be defined by a series of gestalt structure dimensions if one symbol is set as one gestalt structure dimension of the expression methods above. Obviously, this is the expression method of gestalt structure dimension on another level. And each dimension is defined by the set of deeper and similar gestalt structure dimensions. The basic expression method of gestalt structure dimension is achieved through recursion in such way. It appears in the form of tree structure. “A” can be changed in morphology or even in nature and become “B” if the quantity values of a certain dimension or some dimensions are changed on some level. Or in the condition that the similar things are replaced. This is the mechanical way of our creative thinking. Following this thinking, we can express it through artificial intelligence. For example, we can use the production representation, frame representation and semantic representation about knowledge and the only difference is the content of expression.

In the gestalt structure dimension of the similar concepts, the similar and same dimensions are abundant. For example, “fat” and “dense”; as the description of phenomenon, “thin” and “sparse” are all the description of appearance morphology and volume. The measured dimension is the definition of “more” or “less”. Each group is similar. As to “full” and “lack”, there exists the description of quantity besides the definition of “more” or “less”. “Lack” implies that the quantity is below the standard. These two concepts are more abstract. They are not the direct description of appearance morphology. This group of opposite concepts is different with the above groups of concepts in partial dimension quantity. And they are quite different from each other. If the similar concepts with large difference substituted each other, then innovation with large extent will be achieved. They , however, may also be considered as ridiculous.

[Living Example of the Generation of Metaphor]

The information or emotion of virtual (non-sensory) thinking likes an object. The language is the carrier of thinking and words like the container for loading the object. Conversation likes the transmission of information or emotion. On the basis of metaphor generated mechanism, the complicated concept (language is used for communicating information and emotion) consists of three related metaphors organically (quoted form Grammatical Metaphor and Metaphorical Grammar)(lecture of Shen Jiaxuan, p1). The three related metaphors are as follow:

\textcircled{1} information or emotion is an object

\textcircled{2} word is the container for loading the object

\textcircled{3} conversation is the transmission process of object

Next, we will see how to get \textcircled{3} from \textcircled{1} , \textcircled{2} and another related knowledge by using the natural language:

1. Similarity: (information or emotion, like, an object)→metaphor: (information or emotion, is an object)

2. Similarity:(word, like, the container for loading object)→metaphor: (word, is, container)

=similarity: (word, like, (container, load, object))→metaphor: (word, is, container)

=similarity: (word, like, container) [symbol] (container, load, object)→metaphor: (word, is, container)→(word, load, object)

word∈language, thinking unit∈thinking

(language, is, carrier) [symbol] (carrier, load, thinking)

(word, belong to, language)→(word, load, thinking unit)

(word, belong to, carrier)→(container, load, object)

3. Similarity: (conversation, like, the transmission of information or emotion)→metaphor: (conversation, is, the transmission of information or emotion)

=similarity: (conversation, like, (transmission of information or emotion))→metaphor: (conversation, is, (transmission of information or information))

=similarity: (conversation, like, ( . . . , transmission, information or emotion))→metaphor: (conversation, is, ( . . . , transmission, information or emotion))

=similarity: (conversation, like, transmission) [symbol] ( . . . , transmission, information or emotion)→metaphor: (conversation, is, transmission) [symbol] ( . . . , transmission, information or emotion)

Plug into formula 1. and get:

Similarity: (conversation, like, transmission) [symbol] ( . . . , transmission, an object)→metaphor: (conversation, is, transmission) [symbol] ( . . . , transmission, an object)

Object∈Things, plug into the above formula and get:

Similarity: (conversation, like, transmission) [symbol] ( . . . , transmission, object)→metaphor : (conversation, is, transmission) [symbol] ( . . . , transmission, object)→(conversation , process, transmission) [symbol] ( . . . , transmission, object)

( . . . , transmission, object) is the limitation of “transmission”, “transmission” can be changed as the “transmission of object”, so, backtrack and get:

The conversation process is the transmission process.

To generalize the above change,

( . . . , DO, W) equals to WS DON

WS is the adjectivization of the original noun

DON is the nominalization of the original verb

The metaphorical induction of the predicate calculus-like form

Things' abstract model can be determined when the things mainly consist of similarity.

Human beings get knowledge from several kinds of specific scenes and induct the category through their similarity. That is to say the different things with similarity can be identified as the same things from some point of view.

For example, one object is not on the other object, thus the following rules can be achieved:

“To all x, if there doesn't exist a y on the x, then the x is clear”

This rule can expressed by the predicate calculus as:

∀x [symbol] ∃y on(y, x)→clear(x)

This rule contains several different categories' rules on the secondary level.

The knowledge database, which consists of the above model and the model's expressive method of knowledge, will be applied to the generation of metaphor directly.

To apply the predicate calculus-like form to the above expressive model “To all x, if there doesn't exist a y on the x, then the x is clear”

To set ∀ₓ as the whole set, ∃_{y} as arbitrary element of the set, [symbol] ∃_{y} as non-arbitrary element of the set, ∀_{M} as the whole set of the same abstract model

9.2 The Formalized Expression of the Creative Thinking

1. To search the similarity, logical connection and contradictory relation of the gestalt structure dimension of the concept unit under the related searching calculus

The search will be started from the adjacent and the multi-dimensional chain belt (stereo way)will be extended to different kind concept units. Through iteration, new search will be started from each newly searched gestalt structure dimension. Thus, the connection between gestalt structure dimensions of multi-dimensional concept units will be established. This process will be terminated until the connected dimension is the dimension with weak correlation.

If there are different concept units A, B, C, . . . , etc. and each unit can be defined by N gestalt structure dimensions, then A=(a₁, a₂, a₃, . . . , aₙ); B=(b₁, b₂, b₃, . . . , bₙ); Besides, to set a gestalt structure dimension chain with strong correlation: ax→by→cz→. . . .

2. The judgment of the concept units that should be connected with each other

Accroding to (1) of 1. and through the backward reasoning, to judge that whether the concepts related to the gestalt structure dimension of the concept units should be connected with each other and whether the cognitive object could be matched. Obviously, the judgment of the concept units that should be connected with each other is directly related to the cognitive object. The cognitive objects' gestalt structure dimensions that have already been found should be partly similar to the concepts or with other strong correlation. The cognitive object can described as the cognitive object that contains initial concept units or many concept units (there are comprehensive concepts of the concept unit among them). Based on the formula (1), the comprehensive concept F=(AB [symbol] AC [symbol] BC [symbol] . . . ) can be achieved.

3. To constitute the newly combined concept units or comprehensive concept

The constitution mechanism and the process of the newly combined concept units or comprehensive concepts are based on the similarity and cause and effect relation. There are logical correlation between models and they constitute the entirety of current satisfaction(the satisfaction that can be achieved currently).

The calculus is terminated.

The calculus model of innovative thinking

The component factors (elements) of things (like the building) belong to the same set while the divisions of categories are relative. On the more abstract level, things of different kinds will be considered from the same kind.

1. To establish the set of component factors (elements) of things (like building). On the more abstract level, things of different kinds belong to the same set because of the similarity. To establish the constitution structure of this recursion.

2. To some component factors (elements), connection between two kinds of things will be formed according to some similar characteristics on the more abstract level.

3. To select the substitution for the original component factors (elements) and put the substitution into the combination process which to be carried out;

3.1 To make the searching calculus under the constraints include diversity of categories, combined statistic measure, affinity of combined factors, production cost, etc.;

3.2 To search on the more abstract level and find out all substitution of the original factors (elements).

4. The diversity combination of different component factors (elements)

The calculus is terminated.

10. The Machine Learning After the Transformation of Natural Language Predicate Calculus-Like Form

Human beings get knowledge from different and specific scenes. And human beings induce the kind and category by finding the similarity. That is to say some different things with similarities can be identified as the same thing from some points of view. On the basis of this invention, the machine can search automatically and find out the same kind concepts (words) and the contrary concepts (words) through the similarity of words' (concepts) gestalt structure dimension. A series words for expressing behavior can be found out by the same way and stored as the learning result in the word database. Also, the reasoning results can be stored as the new knowledge in the knowledge database.

10.2 To Find Out the Cause and Effect Relation and Get Some Conclusions by Reasoning on the Basis of Learning From the Expression of Facts

For doing this kind of reasoning, we need the knowledge database to provide us with the different concepts (words) with same meaning and the connection of the simplest predicate calculus-like form of the cause and effect relation sentence.

11. The Machine Automatic Programming After the Transformation of the Natural Language Predicate Calculus-Like Form

11.2 The Program that Needed to be Programmed

11.2.1 To Generate the Word Database and Knowledge Database Automatically

At present, the generation will be done manually since the sentences' predicate calculus-like form transformation needs the segmentation of natural language and the decomposition of sentence pattern.

To select the word “read” from the dictionary: read is look at the words and sound or learn. To transform this word and its paraphrase into the word from word database based on Prolog.

[Living Example] Get the word and paraphrase from the dictionary and translate into English firstly:

Read is look at words and sound or learn.

Question 1: Can we connect the electronic dictionary directly thus to transform the Chinese to English? If this can't be done, then to establish the Chinese-English bilingual word database (it is the word database, not the diction database, for example, “ [symbol] —read”).

That's the morphology of “ [symbol] —read” in our self-established word database. All the simplest patterns have their own serial number Wⱼ. Thus to avoid the repetition when other words are defined.

The other words are all established in this way.

12. The Implementation Framework and the Technological Path(with FIG. 3—Diagram of the Implementation Framework)

12.1 To Establish New Code Encoder(Word Database)

To input manually or input the words into new code encoder by using the word database of existing opening code source→to establish digital code word database and input corresponding number—ten Arabic numerals(1, 2, . . . , 9). The number itself is the code with digit identification code. The number is defined by both the digit identification and single number. Word with specific word meaning( [symbol] , [symbol] , [symbol] , [symbol] ), punctuation and word with specific word class can be coded by the number of some interval. As the words for expressing behavior, their position in the sentence determine their attributes. These words will be output differently since they have different constitutions and forms in the word database.

To establish different kinds of behavioral action models as the components of the middle term “DO” of the simplest pattern.

The entirety category concept W contains the individual concept of the same category: W₁, W₂, . . . , wₙ, then use the same number with identification number to encode W₁, W₂, . . . , wₙ and W. That is to use two numbers constitute an array as the code.

Given the regular collocation and set phrase, enough space shall be set apart between the code number when the word database is established in the initial stage. To encode the synonyms with adjacent numbers. The affinity value and the differential value have an inverse ratio. The antonym shall be added the identification.

In the process of word database establishment, to change the set collocation between the words to two or more continuous sequences. If the phrase or idiom is unique, then the collocation words with big statistic probability which are not in the original word database will be input into the word database as the set collocation phrases. This will be one of the machine automatic learning methods.

The set of the segmented simplest thinking model is adopted by the complicated paraphrase of the word database which contains the same expression of scenes (for example, the description of a coffee shop).

After the establishment of the word database, the database has the function of inputting word, searching and comparing, outputting the corresponding digital code.

12.2 To establish the segmentation device of sentence pattern. The segmentation device is connected with the word database and has the sentence pattern consists of the classified register address. To segment sentences of the sequence into the sequence consists of three-term number or array.

To replace the original sentence with the output array of 12.1. Then one sentence becomes a sequence and enters the sentence segmentation device.

12.2.1 The segmentation device has the function of comparing and researching. This function will be proceeded in natural order. The identification applies the minus calculation. It will be succeed if the result is zero.

One of word database functions is comparison and identification.

The comparison and identification calculus model of the phrase consists of more than two words:

1. According to the chronological order, to judge the interval of the phrase code number firstly and then use the phrase code number minus the first code number of the interval of word database in turn. If the result is zero, then the first word of the phrase is the word defined by the first code number; if the result is not zero, then use the remainder minus the next code number until the result is zero. The other word is identified in the same way. Thus the phrases are all compared and identified. If the difference is not zero, then the judgment is that there is no such phrase in the word database.

2. If the comparison and identification of the phrase are not completed, then move on to the comparison of next phrase;

2.1 To repeat the 1. procedure above. If the comparison and identification are still not completed, then

3. To repeat the above procedure until the comparison and identification is completed. To output the result whether the comparison is successful or failure.

4. To output the result.

12.3 To define and paraphrase a word under the predicate calculus-like form and establish the dictionary of natural language

the definition is the most important basic work. It should be implemented under the highly unified level and the gestalt structure dimension should be determined as the basic meaning of some word level-by-level. The level should be more specific and lower. That's the expression way of the dictionary in present day.

To define a word by using a series of predicate form. And to constitute the related example sentence pattern and establish the dictionary of natural language. To establish the dictionary of common words under this method. For example, the paraphrase of “ [symbol] ” on page 22 of the Chinese Characters Origin and Development Dictionary can be expressed by our method:

Original meaning: “ [symbol] ” likes the nascent grass and trees. From the original meaning we know that the derived meanings are all with metaphorical characteristics.

( [symbol] , like, nascent grass and trees)→( [symbol] , is, beginning)→( [symbol] , is, just now)

( [symbol] , like, nascent grass and trees)→( [symbol] , is, nature)→( [symbol] , is, ability)→( [symbol] , is, able people)

( [symbol] , like, nascent grass and trees)→( [symbol] , is, nature)→( [symbol] , is, talent)→( [symbol] , is, talented people)

( [symbol] , like, nascent grass and trees)→( [symbol] , is, vegetation)→( [symbol] , is, wood)→( [symbol] , is, material)→( [symbol] , is, coffin)

To express a word in the predicate calculus-like form is for the transformation of predicate form. Thus the word will be proceeded through predicate calculus and expressed by Prolog. In this way, the matching between words becomes the substitution operation of predicate calculus' recursion and unification.

Each definition of “ [symbol] ” above can be written in the form of predicate

BE(y, Z), or

Z(y).

Then the matching between “people”and “talent” has the basis of logical calculation. In the description of “people” or personification, “people” or personified word matches “talent”. For example, “talented people”, “talented youth”, “the man is talented and the woman is beautiful”, “You are such a talented person!”.

Synonymous sentences can be generated automatically through synonym substitution under the method of word definition above:

The original sentence of “You are such a talented person!” is “you are such an able person!”. (talent, is , ability) equals to (ability, is, talent). To substitute (ability, is, talent) into “You are such an able person!”. The “ability” is substituted by “talent” and we have “You are such an a talented person!”.

Expressed in Prolog language:

[DO](x, y) :-[DO](x, z), BE (y, z).

[DO](x, z),

BE (y, z).

The establishment of word database(dictionary) calculus model:

1. To select a simple word and define it (like the above definition of “ [symbol] ”). Then to establish a word database and define the words appeared in the definition of the word;

2. To repeat the 1. procedure when the definition of the next word is over.

According to this calculus, to define the first word “ [symbol] (like)” which appeared in the definition of “ [symbol] ”. Then to define the other words appeared in the definition of “ [symbol] ” in turn. After this round definition, to start a new definition from the second word “ [symbol] (grass)” which appeared in the definition of “ [symbol] ”. When this new definition is over, to do another similar operation. After the programming of this calculus, the word database can be established on the basis of the paraphrase words which are obtained automatically from the present electronic dictionary.

The other purpose of dictionary is the conventional word-searching. The dictionary is established on the basis of predicate form. That's to say the word is stored in the database in the form of sentence. The example sentence pattern can be output directly and can substitute the related word automatically according to the present sentences. The predicate form provides possibility for this substitution.

12.4 The Establishment of the Word Database

To constitute the word set according to words' categories and list the common phrases under the words' name. Refer to the methods of [symbol] [symbol] [symbol] (Shi Yun He Bi, a book about Chinese poems rhyme). ([1] Shi Yun He Bi edited by Tang Wenlu in Qing Dynasty, published by Shanghai Chinese Classics Book Store in Shanghai)

12.5 The Establishment of Scenario Word and Specialized Word Database

The establishment of the calculus model of scenario word and specialized word database

1. The constitution of scenes (the constitution of word database or knowledge database): constituted by the aggregation of expressive formula of the predicate calculus-like form. Inclusion: the naming of objects; the characteristics of time and space; Determiners: the generation and output of the responding sentences, etc. Knowledge should be accumulated through automatic learning of machine.

2. To express the main objects and related words of the described scene in the form of sequence and this will be the sub-database of the word database. Each word of the sub-database has closely correlation.

3. The scene database consists of the words with scene characteristics. On this basis, to add the describing sentence and paragraph which can be used for the generation of new sentence and paragraph. And this will be expressed in the form of sequence.

4. The word meaning can be classified as: the expression of the naming of things and objects; the expression of the existence, position and quantity of time and space; the expression of behavior; the expression of status; the expression of abstract determiners like “ [symbol] ” , “ [symbol] ”, etc.

To establish the scene word and specialized word databases with the reference of image-text dictionary. For example, to establish the abundant context database and the word database for the generation of sentence with the reference of English-Chinese Image-Text Dictionary (Translated by the translation group of English-Chinese Image-Text Dictionary. English-Chinese Image-Text Dictionary. Published by the Shanghai Scientific and Technical Publishers, 1984, Shanghai)

Excerpt about the coffee house and tea house from page 265 of the dictionary:

The words above represent characteristics of the Britain coffee house and tea house at that time.

The meaning of any word is related to the context. Thus, the most important thing is to point out the word meaning is established under what situation. This is one of the word's identification of word database.

12.6 The Establishment of the Word Database for the Generation of Metaphor

The establishment of the word database for the generation of metaphor should be done under the same way above.

To establish the knowledge database which can be output and used for the generation of sentence

All of the knowledge shall be expressed as the similar calculus-form. On this basis, to establish the knowledge database which can be used for the generation of sentence. The database can combine and output the sentence conveniently. The knowledge predicate form doesn't have to be the simplest pattern of the basic thinking model. Part of the form can be compound.

If it is the simple pattern of WBW(phrase NP consists of adjective and noun), then according to ADJN:

(noun(x), BE, adj(y)), or (noun(x), BE, noun(y))∘

When the noun is the constant N:

(noun(N), BE, adj(y))or (noun(x), BE, noun(y)),

It can be known that different adjective or noun y belong to the same category set N. According to the formula above, y will be classified to category set N automatically when the y is searched from the article. And the machine automatic learning is realized.

For example

N=decorative style[ancient Rome style, Byzantine style, Victorian style, Rococo style, Baroque style, Han Dynasty style of China, Ming Dynasty style of China, Qing Dynasty style of China . . . ]

Living example: to input the sentence(building, has, style) and (style, is, concise). These two sentences are segmented from the original sentence “Building has concise style.”

Among the items of building style, one definition of building is:

(building, has, style)—the existence form of the knowledge sentence is (building, has, style)

The search of the knowledge related to “building” and “style” can be done automatically.

Among the items of the knowledge about artistic modeling style, there is one item of “style”. Style includes many different styles. The styles about building:

Building style [ancient Rome style, Byzantine style, Victorian style, Rococo style, Baroque style, Modern style, Han style of China, Tibetan style of China . . . ]

The existence form of knowledge sentence is (style, is, model(x)).

One of the models is “modern model”. The existence form of the knowledge sentence about “modern model” is (modern model, is, concise).

The realization of the best matching between (building, has, style) and (style, is, model(x)) also needs another limited condition. This condition comes from another input sentence(style, is, concise).

When the search is proceeded to the stage of knowledge language category set (style, is, model(x)), the category set of the knowledge sentence on the next level still needs to be searched. The category set of the status of model definition:

(model(x), is, adj(y))

To do the recursion by on the basis of same words, then get:

(modern model, is, concise)—the both sides of “is” equal to each other.

And put in (style, is, concise), get:

(style, is, modern model)

To backtrack with (building, has, style), and get new sentence:

The building style is modern model.

To output this sentence.

Then we get the output sentence “The building style is modern model.” from the input original sentence “The building has concise style.”

12.7 The Establishment of Multi-Element Word Meaning Net

The following sentence express a piece of knowledge:

Swallow owns a nest from spring to autumn.

The conventional method is the conjunction of the binary relation:
start(own₁, spring), finish(own, autumn),
owner(own₁, swallow), owner(own₁, nests)

To express predicate calculus-like form completely under the method of this invention and program automatically through Prolog language. To establish the knowledge fragment and make it become one part of the word meaning net.

1. A recognition method of natural language for machine thinking, wherein it consists of the following procedures: (1) Establishing a database matching with predicate calculus-like form word meanings; (2) Inputting natural language information; (3) segmentation processing of natural language for machine thinking line by line, and transition to be one or more than one predicate calculus-like form sentence according to segmentation processing rule; (4) Converting multiple predicate calculus-like form sentence to electrical signal recognized by machine, and then input them to center processing unit, and undertake more than one procedures from search, recognition, recursion and substitution to execute functional process with logic deduction, metaphor or creative thinking in order to create new combination for digital codes; (5) converting digital codes combination retrospectively to a new natural language matching original natural language information input and store them as output or learning outcome.

2. A recognition method of natural language for machine thinking according to claim 1, wherein predicate calculus-like form can be defined to be that sentences of natural language are equally constituted by one or one combination of the simplest four thought patterns, each pattern is the simplest consists of predicate and similar to current existing predicate calculus, and define the above four simplest thought patterns to be predicate calculus-like form.

3. A recognition method of natural language for machine thinking according to claim 1, wherein database consists at least a new code word thesaurus with natural number codings, wherein thesaurus is established by manual input or by the way of words entering from word thesaurus with current existing source codes.

4. A recognition method of natural language for machine thinking according to claim 2, wherein segmentation processing rule is that segment the inputting sentence of natural language information into the simplest sentence consisting of at most three in a group, wherein sentences in corresponding paragraph of natural language information convert into a group of sequence set with three in a group after the sentences are segmented.

5. A recognition method of natural language for machine thinking according to claim 4, wherein segmentation rules are realized by the following algorithm models:
(1) Set full stop as sentence meaning termination mark, paragraph as sentence meaning group termination group, whole article as paragraph meaning group in a sentence; Clauses search middle term predicate in simplest sentence and accordingly do comparisons with word thesaurus by the boundary of comma;
(1.1) Define sentence elements of front term and back term in the first level, front term of sentence as the first term in the simplest sentence in the first level, back term as the third term in the simplest sentence in the first level;
(1.2) If a omission occurs in the middle predicate of original sentence, then predicate will be compensated, and repeat step 1.1;
(2) Make second level division for the front and back term of sentence accordingly, and repeat the same division process with step 1;
(3) The first term of the next level of the simplest formula is restricted subject of determiner, the second term adds predicate, the third term is the determiner;
(4) Execute division process above on the next level until the whole sentence complete division.

6. A recognition method of natural language for machine thinking according to claim 5, wherein search algorithm model of the sentence predicate is:
(1) Make comparison between word and word thesaurus accordingly in a sentence, then word thesaurus outputs attribute/speech in it until search out the first predicate and continue the after search; Search completes if no other predicate occurs; Behavior maker is the word former judging words or verb, and behavior receiver is the latter so that to find out the simplest sentence;
(2) If we search on the second predicate and continue the later search, search complete with no other predicates; Predicate former is behavior maker and latter is the receiver so that the simplest sentence complex structure is found out.

7. A recognition method of natural language for machine thinking according to claim 2, wherein the nature language information is convert into predicate calculus-like form. Then the processes of automated reasoning and association are as follow: After division the sentence turns to be a simplest thinking mode consisting of words that three in a group. The processes of automated reasoning and association are realized by applying searching match identification and recursive substitution calculation process.

8. A recognition method of natural language for machine thinking according to claims 2 and 3, wherein inference algorithm model is created by similar predicate with conversion of nature language information:
(1) According to the principle of time priority, we use the third term of the first sequence of the first sentence to minus the first term of the first sequence of the second sentence. If this results zero and the second term of the first sequence of the first sentence minus the second term of the second sequence equals zero, then the third term of the first sequence of the first sentence shall be replaced by the first term of the second sequence of the second sentence; the new first sequence of the first sentence is established.
(1.1) If we don't have the result above, then use the third term of the first sequence of the first sentence to minus the first term of the third sequence of the secondary two sentences. If this results zero and the second term of the first sequence of the first sentence minus the second term of the third sequence of the secondary two sentences equals to zero, then the third term of the first sequence of the first sentence shall be replaced by the first term of the third sequence of the secondary two sentences; the new first sequence of the first sentence is established;
(2) To use the third term of the first sequence minus the first term of the secondary sequence (the first term of the secondary sequence has finished the calculation of step 1). If this results zero and the second term of the first sequence minus the second term of the secondary sequence (the second term of the secondary sequence has finished the calculation of step 1) equals zero, then the third term of the first sequence shall be replaced by the first term of the secondary sequence which has finished the calculation of step 1; the new first sequence is established;
(3) To carry on the procedure above until the procedure can not be proceeded, then stop the procedure; output the new first sequence and this is the result of reasoning.
(4) If the selected sequence can not be proceeded through the procedure above, then to select the secondary sequence for the procedure above;
(5) The conclusion shall be outputted whether there is reasoning result or not. The incomplete logical reasoning and judging calculus model is based on the calculation of the similar predicate calculus model which converted from the natural language:
The incomplete logical reasoning and judging calculus model is based on the calculation of the similar predicate calculus model which converted from the natural language:
(1) In the sentence pattern, to use the individual replace the kind and take individual as the assignment of the variable kind. Or to use kind replace individual. This will depend on the demand of the reasoning target. The terminal abstract concepts (like the totally different abstract concept “order” and “disorder”, “good” and “bad”) are in the same relation with their inclusive specific concepts.
(2) In the sentence pattern, the sentence will be null if the reasoning result is that the sub-sentence contradicts to the main expression.
(3) In the same action chain, the main behavioral agent which has the causal relation can replace the latter with the former under the causal order. (This will be determined by the uniqueness limited by the time and space of the causal relation).
(4) In the replacement calculation, if the entire kind concept W includes the individual concepts which belong to the same kind, like w₁, w₂, . . . , wₙ. And w₁, w₂, . . . , wₙ respectively equals to W, then W can be replaced in the sentences(the equivalence relation between the universal concept and the specific concept).
(5) WHAT₁ BE WHAT₂ is reversed to be WHAT₂ BE WHAT₁, and they are equivalent. In the mode of WHAT₁ Do WHAT₂, Do equals to WHAT₂.
(6) As the third term in the sentence, WⱼDW_{J+1} can be independent and has entire meaning. It can be formed as a new sentence by combination with WDW. As the third term, WⱼD can be canceled. And Wⱼ₊₁ is reserved only. The sentence will be reduced into the central meaning sentence.
(7) To eliminate the determinative expression of DO which is one of the four basic thinking models that initially segmented from the sentence. And to reserve WHAT of the last DO of the same sentence. If WHAT belongs to BE kind, than both sides of BE equal to each other and become two simplified sentences.
(8) Three parameters of the basic model (fully segmented) can replace each other in the same condition excluding BE. The same word in each sentence can be replaced with an equivalent word.

9. The segmentation and machine translation of the natural language similar predicate calculus. The automatic translation calculus model of the natural language similar predicate:
(1) The segmentation of sentences: The basic translation sentences are based on the simplest pattern of the basic thinking models and added with the sentences of each word's determiners. This sentence pattern is the same in both English and Chinese.
(2) The attributes of behavior effect of the behavioral agent shall be determined specifically in English and omitted in Chinese.
(3) The abstract meaning of “ existence ” shall be expressed in English and omitted in Chinese.
(4) “WHAT₁ BE of WHAT₂” equals to“WHAT₁ HAS WHAT₂”
(5) There are many abotic behavioral agents in English while less in Chinese. Mostly, the abotic behavioral agents appeared as metaphor and are quite different in the choice of words.
(6) “It ” appears a lot as the behavioral agent in English. For the balance of the sentence, the clause is usually put in the end of the sentence and “it” is put in the initial as the subject. During the process of conversion, the passive voice shall be replaced with active voice.
(7) To replace the translation words of the segmented simplest pattern and generate the translation sentence through backtracking. The two central sentences completely correspond to each other by comparing Chinese with English.

10. Natural language expression of mathematical machines thinking and mathematical problem solving algorithm model on predicate calculus-like form:
(1) Establishment of problem-solving template. Problem-solving template should include synonyms and set words in different positions in the simplest sentence as single synonyms or synonymy determiner word list[x], the module caters to all the natural language with the same meaning.
(2) Cut the language expression mathematical problems into predicate calculus-like representation form;
(3) A series of Recursion and the replacement operation is based on the same words corresponding to problem solving template to realize the problem solving process;
(4) Enter the calculation program to calculate;
(5) Automatic backtracking operation and will generate output statement on the answers.

11. Machine learning after predicate calculus-like form convertion of natural words: By similarity of words (concept) Gestalt structure dimensions, the machine can automatically search recognition, to find out the same genus concept (s) and an opposite concepts (words), to find out a series of vocabularies expressing behaviors, and be saved in word thesaurus management module as learning results by adopting the invention.

12. Machine automatic programming after predicate calculus-like form convertion of natural words: To realize machine automatic programming generally on predicate calculus-like form convertion of natural words by adopting the invention.

13. A recognition method of natural language for machine thinking, wherein it consists of human Interface module, sentence segmentation module, central processing unit, sentence synthesis module and database module, wherein sentence segmentation module and sentence synthesis module are connected with input and output ends of central processing unit by electrical signal, wherein database module includes at least word thesaurus management module.

14. A recognition method of natural language for machine thinking according to claim 13, wherein the database module is multi-database synergy module, it consists of knowledge base management module, scene base management module, multiple semantic network management module and Metaphor network database management system.
